(19) United States
(12) Patent Application Publication
(10) Pub. No.: US 2012/0309510 A1
(43) Pub. Date: Dec. 6, 2012

(54) PERSONALIZED INFORMATION FOR A NON-ACQUIRED ASSET

(76) Inventors: Nathan D. Taylor, Scotts Valley, CA (US); Marcel van Os, San Francisco, CA (US); Michael D. Lampell, Novato, CA (US)

(21) Appl. No.: 13/398,592

(22) Filed: Feb. 16, 2012

Related U.S. Application Data
(60) Provisional application No. 61/520,094, filed on Jun. 3, 2011.

(51) Int. Cl. A63F 9/24; G06F 21/00

(52) U.S. Cl. 463/29; 726/4

(57) ABSTRACT

Described herein are methods and systems for providing personalized information for a non-acquired asset. The personalized information can be based on data related to the user's friends, friends of the user's friends, and the user. In one embodiment, a computer-implemented method is performed by processing logic that allows a user to access a first user account. The processing logic causes a system to present at least a first asset that is inaccessible by the first user account. The first asset may be associated with a second user account that is linked to the first user account. The processing logic may receive a selection of the first asset. The processing logic, in response to the selection, causes the system to automatically present data related to the first asset. The data may be personalized to the first user account and based on the second user account.

### CLAIM TO PRIORITY

This application claims the benefit of commonly assigned U.S. Patent Application No. 61/520,094 entitled “Personalized Information For A Non-Acquired Asset” filed on Jun. 3, 2011 by Nathan D. Taylor, et al., the disclosure of which is hereby expressly incorporated herein by reference.

### TECHNICAL FIELD

Embodiments of the present invention relate to systems and methods that provide personalized information for a non-acquired asset.

### BACKGROUND

Various devices such as electronic devices, computing systems, portable devices, and handheld devices have software gaming applications. These devices can network with each other for a multi-player gaming experience.

One prior gaming device allows players to interact with each other online. This gaming device allows the sharing of a game and accomplishments between players. A user with a game console accesses an online game service to share the gaming experience with other players.

However, this prior approach has limitations in terms of navigating a hierarchy of gaming options and playing games with other players.

### SUMMARY

Described herein are methods and systems for providing personalized information for a non-acquired asset. The personalized information can be based on data related to the user's friends, friends of the user's friends, and the user. In one embodiment, a computer-implemented method is performed by processing logic that allows a user to access a first user account. The processing logic causes a system to present at least a first asset that is inaccessible by the first user account. The first asset may be associated with a second user account that is linked to the first user account. The processing logic may receive a selection of the first asset. The processing logic, in response to the selection, causes the system to automatically present data related to the first asset. The data may be personalized to the first user account and based on the second user account.

The data may be personalized to the first user account and based on the second user account by comparison of data derived from the first and second user accounts. In one embodiment, the first user account and the second user account may be associated with the user. In another embodiment, the first user account is associated with the user and the second user account is associated with a friend of the user.

The present disclosure includes systems and devices that perform these methods, including data processing systems which perform these methods, and machine readable media which when executed on data processing systems cause the systems to perform these methods.

### BRIEF DESCRIPTION OF THE DRAWINGS

The present invention is illustrated by way of example, and not by way of limitation, in the figures of the accompanying drawings and in which:

FIG. 1 illustrates a general network topology implemented in one embodiment of the present invention;

FIG. 2 illustrates an exemplary extensible architecture of exemplary hubs provided by a module located on a client system in one embodiment of the present invention;

FIGS. 3A and 3B each illustrate exemplary hubs of the extensible architecture provided by a module located on a client system in one embodiment of the present invention;

FIG. 4 illustrates a flow diagram in one embodiment of the present invention for a computer-implemented method 400 of providing an extensible architecture for navigating a data hierarchy with hubs;

FIG. 5 illustrates a flow diagram in one embodiment of the present invention for a computer-implemented method 500 of providing a game center on a client system with a game center module providing an extensible architecture for navigating a data hierarchy with hubs;

FIG. 6A illustrates an exemplary user interface 900 that is generated upon initiation of the game center module in one embodiment of the present invention;

FIG. 6B illustrates an exemplary user interface 925 that is generated upon selection of a profile option 910 in one embodiment of the present invention;

FIG. 6C illustrates an exemplary user interface 960 having account information options in one embodiment of the present invention;

FIG. 6D illustrates an exemplary user interface 970 that is generated upon selection of a profile option 910 in one embodiment of the present invention;

FIG. 7 illustrates an exemplary user interface 1000 having a list of friends 1050 in one embodiment of the present invention;

FIG. 8 illustrates an exemplary user interface 1100 having friend details of a particular friend and associated with a hub in one embodiment of the present invention;

FIG. 9 illustrates an exemplary user interface 1191 having friend details of a particular friend in one embodiment of the present invention;

FIG. 10 illustrates an exemplary user interface 800 having personalized information options for a selected game that is not owned by the user in one embodiment of the present invention;

FIG. 11 illustrates a flow diagram in one embodiment of the present invention for a computer-implemented method 1100 of providing personalized information for a non-acquired asset;

FIG. 12 illustrates an exemplary user interface 1200 having a list of games 1250 in one embodiment of the present invention;

FIG. 13 illustrates an exemplary user interface 1300 having game details for a selected game and associated with a hub in one embodiment of the present invention;

FIG. 14 illustrates an exemplary user interface 1400 having a leaderboard in one embodiment of the present invention;

FIG. 15 illustrates an exemplary user interface 1491 having a leaderboard in one embodiment of the present invention;

FIG. 16 illustrates an exemplary user interface 1002 having a list of friends 1050 that have been categorized based on points in one embodiment of the present invention;

FIG. 17 illustrates an exemplary user interface 1700 having achievements in one embodiment of the present invention;

FIG. 18 illustrates an exemplary user interface 1850 having a comparison of achievements in one embodiment of the present invention;

FIG. 19 illustrates an exemplary user interface 1900 having recent players from recent matches with the user in one embodiment of the present invention;

FIG. 20 illustrates an exemplary user interface 2000 having details for a player from recent matches in one embodiment of the present invention;

FIG. 21 illustrates an exemplary user interface 2100 having list of notifications (e.g., friend requests, updates) in one embodiment of the present invention;

FIG. 22A illustrates an exemplary user interface 2200 having details for a received friend request in one embodiment of the present invention;

FIG. 22B illustrates an exemplary user interface 2300 for generating a friend request in one embodiment of the present invention;

FIG. 23 illustrates an exemplary user interface 860 have personalized information for a game that is not owned by the user in one embodiment of the present invention;

FIGS. 24-27 illustrate exemplary user interfaces designed for certain systems in one embodiment of the present invention;

FIGS. 28 and 29 illustrate exemplary user interfaces 840 and 880 having personalized information for a game that is not owned by the user in one embodiment of the present invention;

FIG. 30 illustrates a touch I/O system 3001 that can receive touch input for interacting with computing system 3003 via wired or wireless communication channel 3002 in one embodiment of the present invention;

FIG. 31 shows a wireless system which includes the capability for wireless communication in one embodiment of the present invention;

FIG. 32 is a block diagram illustrating an exemplary API architecture, which may be used in one embodiment of the present invention;

In FIG. 33 (“Software Stack”), in one embodiment of the present invention, applications can make calls to Services A or B using several Service APIs and to Operating System (OS) using several OS APIs; and

FIG. 34 illustrates a flow diagram in one embodiment of the present invention for a computer-implemented method 3400 of providing personalized information for a non-acquired asset.

### DETAILED DESCRIPTION

Described herein are methods and systems for providing personalized information for a non-acquired asset. The personalized information can be based on data related to the user's friends, friends of the user's friends, and the user. In one embodiment, a computer-implemented method is performed by processing logic that allows a user to access a first user account. The processing logic causes a system to present at least a first asset that is inaccessible by the first user account. The first asset may be associated with a second user account that is linked to the first user account. The processing logic may receive a selection of the first asset. The processing logic, in response to the selection, causes the system to automatically present data related to the first asset. The data may be personalized to the first user account and based on the second user account.

In one embodiment, a game center module located on a system provides the game center having one or more assets (e.g., games). The game center may be a central area in a gaming system that provides information for numerous games, clients, players, etc., or any combination thereof. The games can be educational, have utility, provide entertainment, or be any category of software applications provided by an application service (e.g., application store).

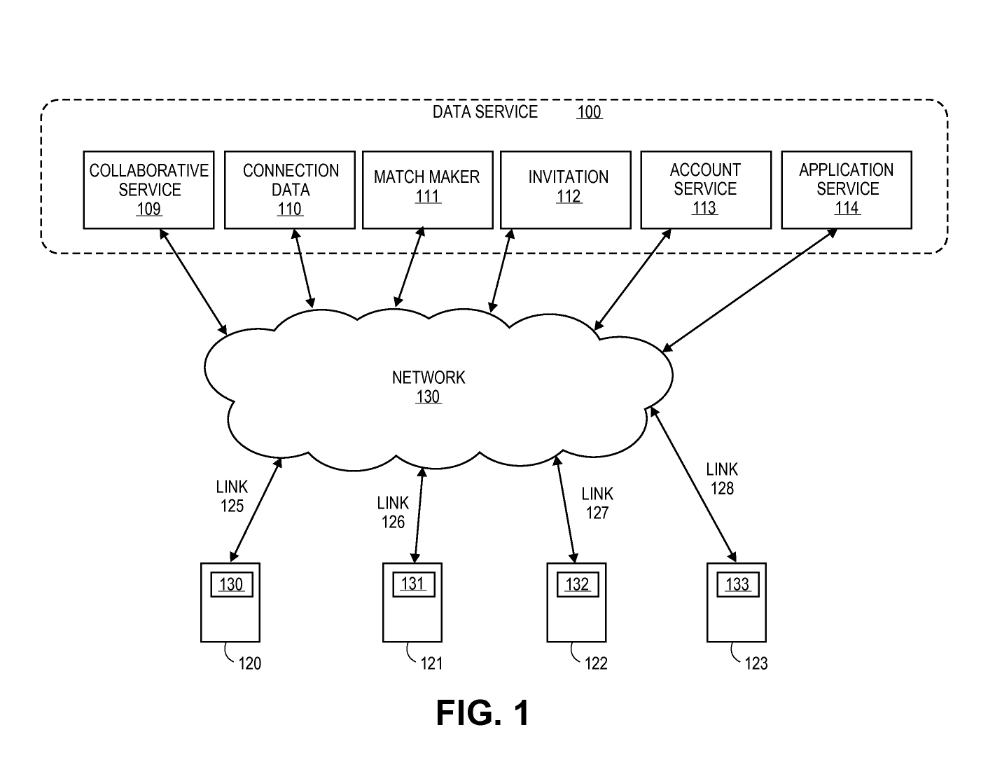

As illustrated in FIG. 1, a general network topology implemented in one embodiment of the present invention can include a group of “client” or “peer” computing systems 120-123, respectively, communicating with one another and with one or more services 109-114 over a network 130. Although illustrated as a single network cloud in FIG. 1, the “network” 130 can be comprised of a variety of different components including public networks such as the Internet and private networks such as local Wi-Fi networks (e.g., 802.11 n home wireless networks or wireless hotspots), local area Ethernet networks, cellular data networks, and WiMAX networks, to name a few. For example, system 120 may be connected to a home Wi-Fi network represented by network link 125, system 121 may be connected to a 3G network (e.g., Universal Mobile Telecommunications System (“UMTS”), High-Speed Uplink Packet Access (“HSUPA”), etc) represented by network link 126, system 122 may be connected to a WiMAX network represented by network link 127, and system 123 may be connected to a public Wi-Fi network represented by network link 128. Each of the local network links 125-128 over which the systems 120-123 are connected may be coupled to a public network such as the Internet, thereby enabling communication between the various systems 120-123 over the public network. However, if two systems are on the same local or private network (e.g., the same Wi-Fi network), then the two systems may communicate directly over that local/private network, bypassing the public network. It should be noted, of course, that the underlying principles of the present disclosure are not limited to any particular set of network types or network topologies.

Each of the systems 120-123 illustrated in FIG. 1 can communicate with a data service 100 that may include a collaborative service 109 (e.g., game service, music creation service, document creation service, video service), a connection data exchange (CDX) service 110, a matchmaker service 111, an invitation service 112, an account service 113, and an application service 114. In one embodiment, the collaborative service 109 enables users to collaborate with collaborative applications. For example, the collaborative service 109 may be a video service that enables users to collaborate for viewing video content. The collaborative service 109 may be a game service that enables users to collaborate for multi-player gaming applications. The game service may include or access any of the services 110-114 to provide a game center. The game service may include or access any of the services 110-114. For example, the game service may include services 111 and 112. The services 109-114 can be implemented as software executed across one or more physical computing systems such as servers. As shown in FIG. 1, in one embodiment, the services may be implemented within the context of a larger data service 100 managed by the same entity (e.g., the same company) and accessible by each of the systems 120-123 over the network 130. The data service 100 can include a local area network (e.g., an Ethernet-based LAN) connecting various types of servers, a storage area networks (“SANs”) and databases. In one embodiment, the databases store and manage data related to each of the user systems (e.g., client systems, computer systems, mobile systems) 120-123 and the users of those systems (e.g., user account data, system account data, user application data, etc.).

In one embodiment, a game center module 130-133 is located on each system 120-123. The game center module is associated with a game center software application that manages a game center in conjunction with the game service. The game center module includes sub-modules (e.g., profile, friends, games, notifications) for managing the game center and providing the gaming experience for multi-player gaming.

For example, in one embodiment of the present invention, each user is identified within the friend service by either a unique destination signaling identifier (“DSID”) or a unique handle. In one embodiment, a DSID is used to identify users who are known to have accounts on the friend service. These users are sometimes referred to as “in-network users.” A handle can be used to identify users who are not known to have accounts on the friend service 100. These users are sometimes referred to as “out-of-network users.” This may include users who have not yet registered an account on the friend service and/or users who have an account on the friend service but who have not yet associated a particular handle with their account.

A “friend” may be defined as a user having an account that is associated or linked with an account from another user.

The matchmaker service 111 can match two or more systems for a collaborative peer to peer (P2P) session based on a specified set of conditions. For example, users of two or more of the systems may be interested in playing a particular multi-player game. In such a case, the matchmaker service 111 may identify a group of systems to participate in the game based on variables such as each user's level of expertise, the age of each of the users, the timing of the match requests, the particular game for which a match is requested and game-specific variables associated with the game. By way of example, and not limitation, the matchmaker service 111 may attempt to match users with similar levels of expertise at playing a particular game. Additionally, adults may be matched with other adults and children may be matched with other children. Moreover, the matchmaker service 111 may prioritize user requests based on the order in which those requests are received. The underlying principles of the present disclosure are not limited to any particular set of matching criteria or any particular type of P2P application. More details in regards to the matchmaker service are described in co-pending U.S. Pat. No. 61/321,842.

In response to a match request, the matchmaker service 111 can coordinate with the CDX service 110 to ensure that all matched participants receive the necessary connection data for establishing P2P sessions in an efficient and secure manner.

In one embodiment, the invitation service 112 also identifies systems for participation in collaborative P2P sessions. However, in the case of the invitation service 112, at least one of the participants is specifically identified by another participant. For example, the user of system 120 may specifically request a collaborative session with the user of system 121. As with the matchmaker service 111, in response to an invitation request, the invitation service 112 can identify the set of participants and coordinate with the CDX service 110 to ensure that all participants receive the necessary connection data for establishing P2P sessions in an efficient and secure manner.

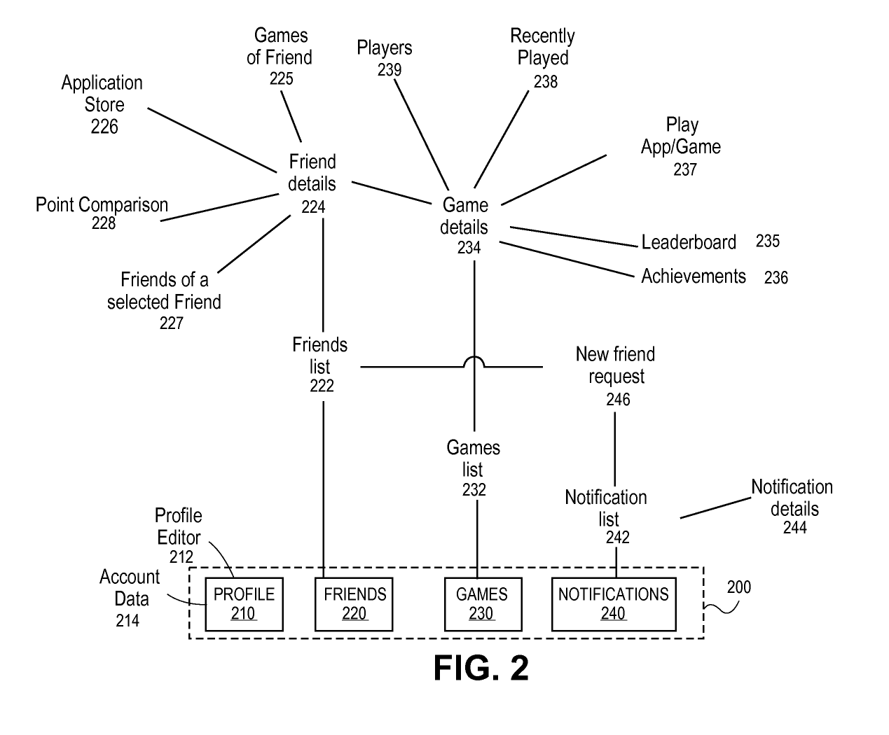

FIG. 2 illustrates an exemplary extensible architecture 202 of hubs provided by a module located on a client system in one embodiment of the present invention. The module 200 (e.g., game center module, video module) includes a profile sub-module 210 for providing user profile information (e.g., status information, representation, account data), a friends sub-module 220 for providing information related to a user's friends (e.g., list of friends, editing of friends, games played with friends), a sub-module 230 (e.g., gaming sub-module, video sub-module) for providing gaming information for games owned by the user or video information, and a notifications sub-module 240 for providing various types of notifications (e.g., requests, gaming updates, etc.). Each of the sub-modules may provide a user interface with selectable options.

The profile sub-module 210 associated with a profile option provides access to the profile editor option 212 (e.g., avatar editor option) and account data option 214 of the user. An avatar is a representation of a computer user or their alter ego. An avatar is often in the form of a three-dimensional (3D) model used in computer games or a two-dimensional (2D) icon or picture or image or clip art used on Internet forums, social networks and other communities. Avatars can also be used in video games, including online interactive gaming environments. The avatar editor option can create and edit a user's avatar.

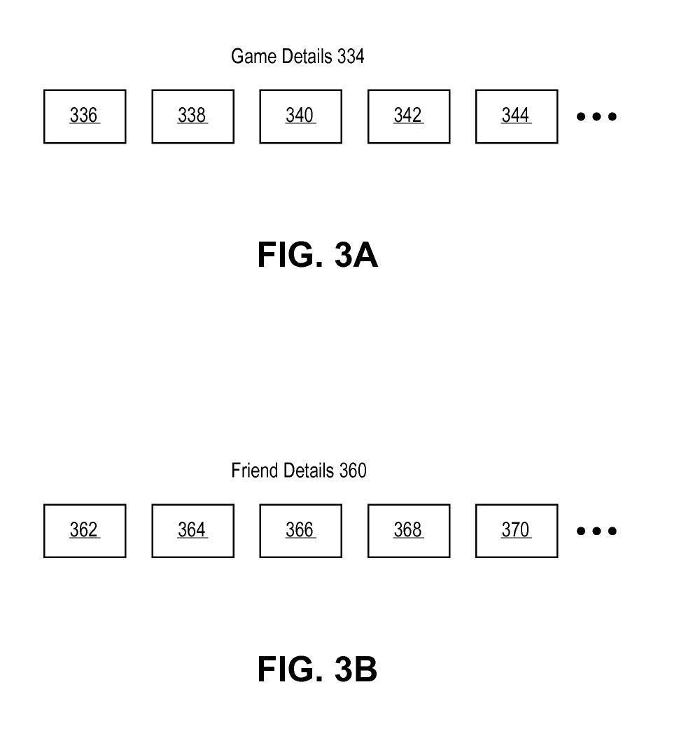

A friends sub-module 220 associated with a friends option provides access to a friends list option 222. These friends can be editing by the user. The list of friends may be friends within one or more networks (e.g., gamecenter network). Certain information (e.g., name, status, representation) regarding each friend is included in the list of friends. A user can obtain additional information regarding a friend by selecting one of the friends. This user selection generates friend details hub option 224 for the selected friend. These details for the selected friend may include a representation (e.g., avatar), a status, statistics, a list of games played with the friend, a list of other games in common with the friend, a list of games owned by the friend but not owned by the user, etc. The hub option 224 provides access to a navigation region with different types of navigation options and associated data buckets (e.g., games of selected friend 225, app store 226, point comparison with selected friend 228, friends of a selected friend 227, developer group, etc.). FIG. 3B illustrates an exemplary hub option of an extensible architecture provided by a module located on a client system in one embodiment of the present invention. Hub option 360 (e.g., friend details hub option 360, friend details hub option 224) includes data buckets 362 (e.g., point comparison with selected friend), 364 (e.g., achievement points for the selected friend), 366 (e.g., games of selected friend), 368 (e.g., friends of the selected friend), 370 (e.g., app store), etc.

A gaming sub-module 230 associated with a gaming option provides access to a games list option 232. Games can be added or deleted from the list of games. Certain information (e.g., game manufacturer, game name, rating) regarding each game may be included in the list of games. A user can obtain additional information regarding a game by selecting one of the games. This user selection generates game details hub option 234 for the selected game. The games details hub option 234 can be accessed from any other hub option (e.g., friend details hub option 224, etc.) or any option directly linked to games details hub option 234. The hub option 234 provides access to different types of data buckets (e.g., leaderboard, achievements, players, recently played games, tell a friend (TAF), developer group, etc.). FIG. 3A illustrates an exemplary hub of an extensible architecture provided by a module located on a client system in one embodiment of the present invention. Hub option 334 (e.g., games details hub option 334, games details hub option 234) includes data buckets 336 (e.g., leaderboard), 338 (e.g., achievements), 340 (e.g., players), 342 (e.g., recently played games), 344 (e.g., TAF), etc.

A notifications sub-module 240 associated with a notification option provides access to a notification list option 242. These notifications can be edited by the user. The list of notifications may be outgoing requests that are sent or incoming requests that have been received within one or more networks (e.g., gamecenter network). The notification may include gaming updates for a certain game, a notification regarding a new release of a game or a new game being released, etc. Certain information (e.g., name, status, representation) regarding each request is included in the list of notifications. A user can obtain additional information regarding a notification by selecting one of the notifications. This user selection generates notification details option 244 for the selected notifications. In one embodiment, these details for the selected notifications (e.g., request) may include an invitation to a friend, etc. A user can select an invitation option 246 to invite a new friend. If a new friend is invited at option 246, then option 222 is accessed. Other options and relationships between the options can be provided by the game center module in addition to those illustrated in FIG. 2.

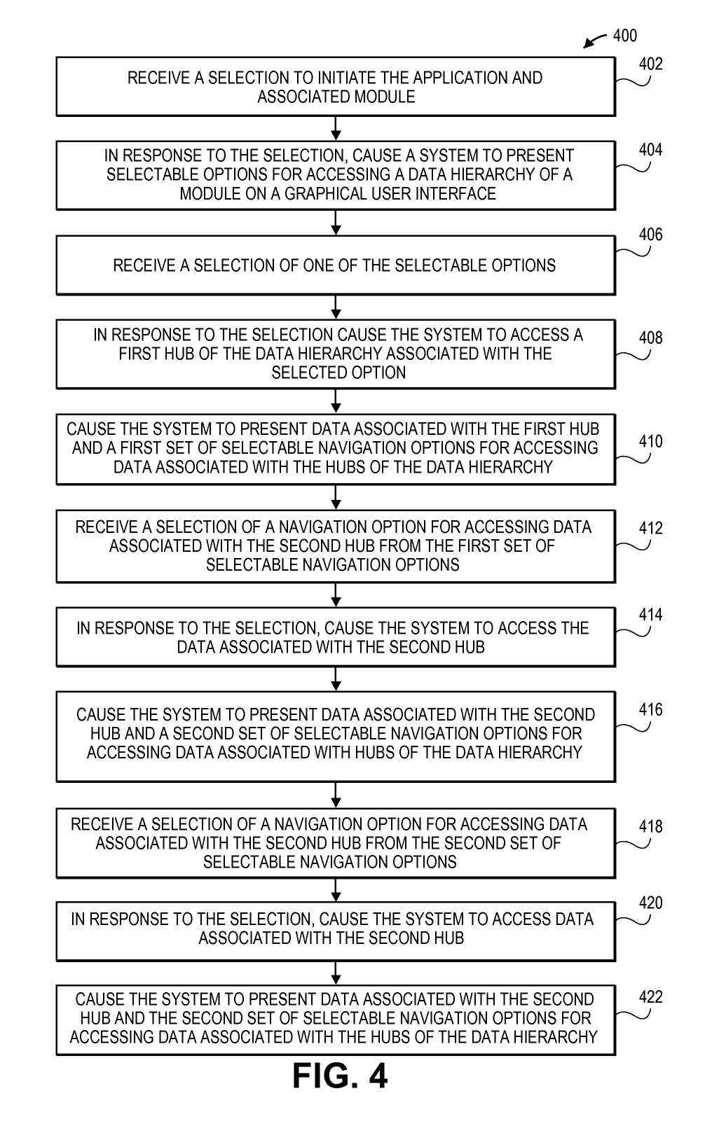

FIG. 4 illustrates a flow diagram in one embodiment of the present invention for a computer-implemented method 400 of providing an extensible architecture for navigating a hierarchy on a client system. The computer-implemented method 400 is performed by processing logic that may comprise hardware (circuitry, dedicated logic, etc.), software (such as is run on a general purpose computer system or a dedicated machine or a system), or a combination of both. In one embodiment, the computer-implemented method 400 is performed by the module 200 (e.g., game center module, video module) located on a client system.

At block 402, the processing logic receives a selection to initiate the application and associated module. At block 404, in response to the selection, the processing logic causes a system to present selectable options for accessing a data hierarchy of a module on a graphical user interface. At block 406, the processing logic receives a selection of one of the selectable options. At block 408, in response to the selection, the processing logic causes the system to access a first hub of the data hierarchy associated with the selected option. At block 410, the processing logic causes the system to present data associated with the first hub and a first set of selectable navigation options for accessing data associated with the hubs of the data hierarchy. At block 412, the processing logic receives a selection of a navigation option for accessing data associated with the second hub from the first set of selectable navigation options. At block 414, in response to the selection, the processing logic causes the system to access the data associated with the second hub. At block 416, the processing logic causes the system to present data associated with the second hub and a second set of selectable navigation options for accessing data associated with the hubs of the data hierarchy. At block 418, the processing logic receives a selection of a navigation option for accessing data associated with the second hub from the second set of selectable navigation options. At block 420, in response to the selection, the processing logic causes the system to access data associated with the second hub. At block 422, the processing logic causes the system to present data associated with the second hub and the second set of selectable navigation options for accessing data associated with the hubs of the data hierarchy.

A user can navigate to different hubs and associated hub options of the hierarchy laterally in the extensible architecture while keeping the ordering of objects for different user interfaces. In one embodiment, header information is located in a first region of the user interface and navigation options are located in a second region of the user interface. The data presented in a third region changes depending on the hub (e.g., branch) of the hierarchy that is accessed.

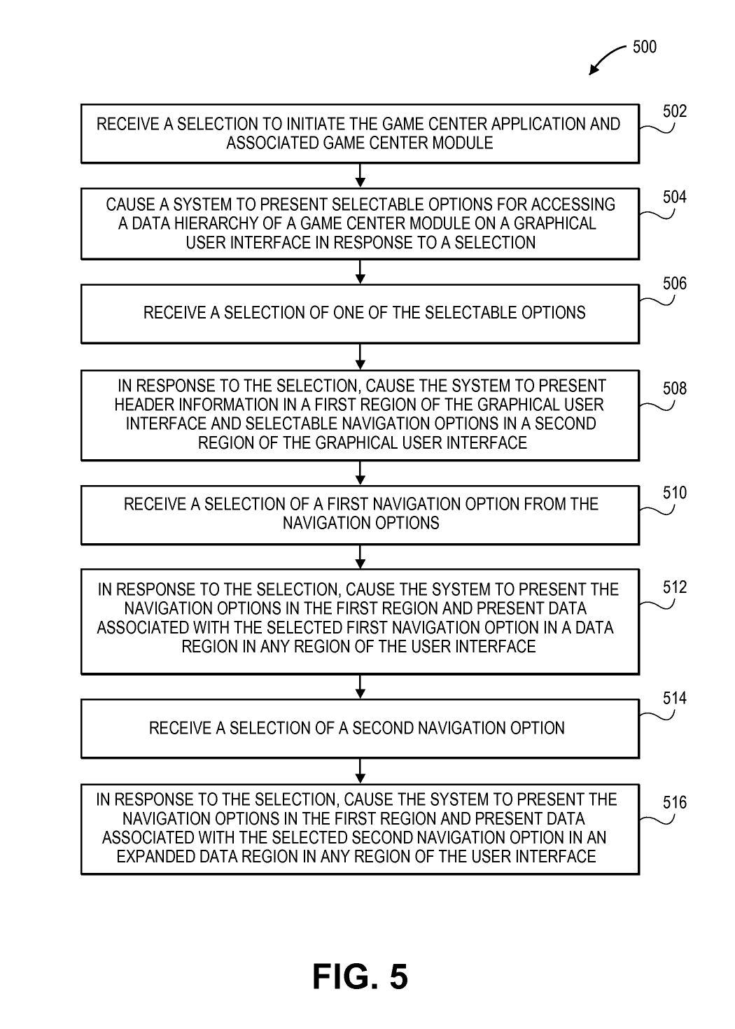

FIG. 5 illustrates a flow diagram in one embodiment of the present invention for a computer-implemented method 500 of providing an extensible architecture for navigating a hierarchy on a client system. The computer-implemented method 500 is performed by processing logic that may comprise hardware (circuitry, dedicated logic, etc.), software (such as is run on a general purpose computer system or a dedicated machine or a system), or a combination of both. In one embodiment, the computer-implemented method 500 is performed by the module 200 (e.g., game center module) located on a client system.

At block 502, the processing logic receives a selection to initiate the game center application and associated game center module. At block 504, the processing logic can cause a system to present selectable options for accessing a data hierarchy of a game center module on a graphical user interface in response to a selection. At block 506, the processing logic receives a selection of one of the selectable options. For example, the processing logic may receive a selection of friends options 220 and friends list option 222. Alternatively, the processing logic may receive a selection of games options 230 and games list option 232.

At block 508, the processing logic can, in response to the selection, cause the system to present header information in a first region of the graphical user interface and selectable navigation options in a second region of the graphical user interface. The navigation options (e.g., leaderboard, achievements, points, friends, players, recently played games, tell a friend (TAF), developer group, etc.) may be associated with one or more hubs and hub options (e.g., friends details hub option, games details hub option, etc.) and these hubs may be laterally located within the hierarchy of the extensible architecture for the module. In another embodiment, the processing logic can cause the graphical user interface of the system in response to initiation of the game center application to automatically provide access to the hubs.

At block 510, the processing logic may receive a selection of a first navigation option from the navigation options. At block 512, in response to the selection, the processing logic can cause the system to present the navigation options in the first region and present data associated with the selected first navigation option in a data region in any portion of the user interface. At block 514, the processing logic can receive a selection of a second navigation option. At block 516, the processing logic, in response to the selection, can cause the system to present the navigation options in the first region and present data associated with the selected second navigation option in an expanded data region in any region of the user interface.

A user can navigate to different hubs of the hierarchy laterally in the extensible architecture while maintaining the flow and texture of objects within the user interfaces. For example, the data for a particular navigation option may include a list of games owned by the user. Alternatively, the data may include a list of games not owned by the user and owned by a friend of the user. The user interfaces for each case would be similar, except for the change in the data.

The user does not need to make numerous user selections in the forward or backwards direction from one portion of the architecture 200 to a different portion. Rather, the user experience is enhanced by being able to quickly move from one portion of the hub architecture 200 to a different portion.

In one embodiment, header information (e.g., a representation (e.g., 2D avatar, 3D avatar) for the user (e.g., Mel), a status message, alias information, photographic image of the user, etc. is located in a first region of the user interface and navigation options are located in a second region of the user interface. The data presented in a third region changes depending on the hub (e.g., branch) of the hierarchy that is selected. The display area of a device can be effectively utilized by removing the header information for certain user interfaces, moving the navigation options into the first region (e.g, near an upper boundary of the display), and expanding the data into the remainder of the display so that the user can easily view and navigate data.

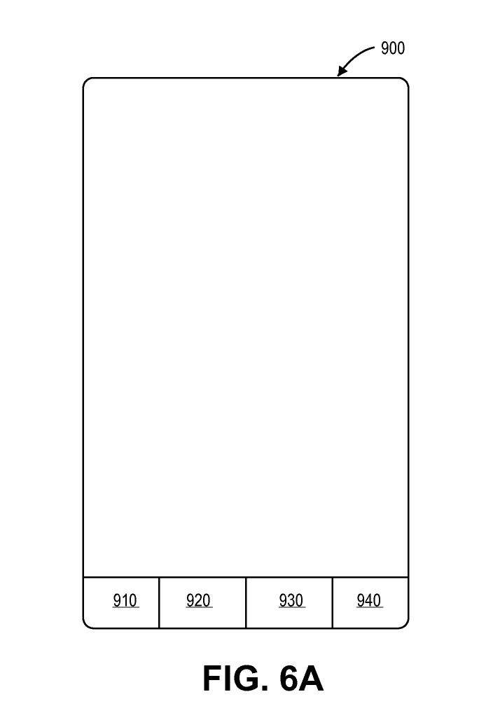

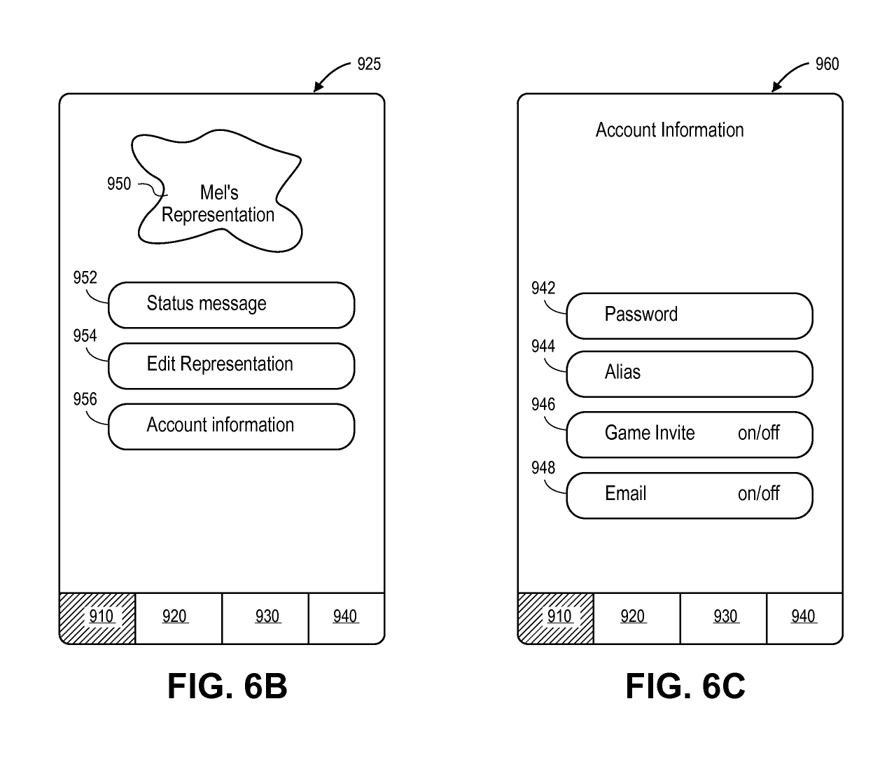

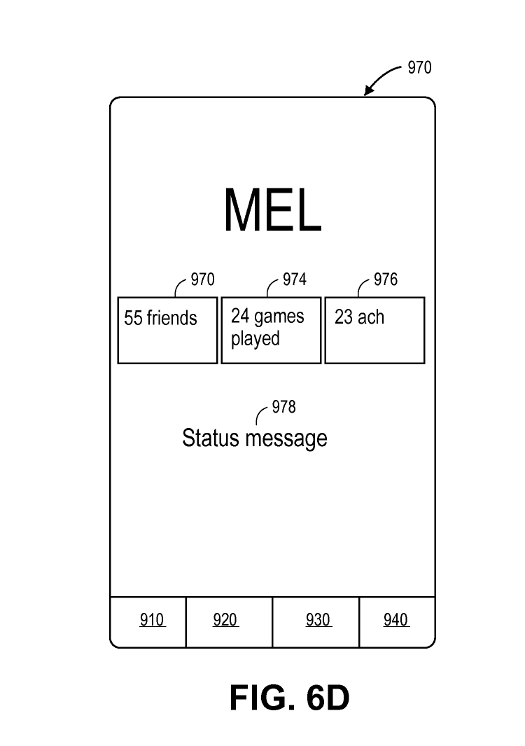

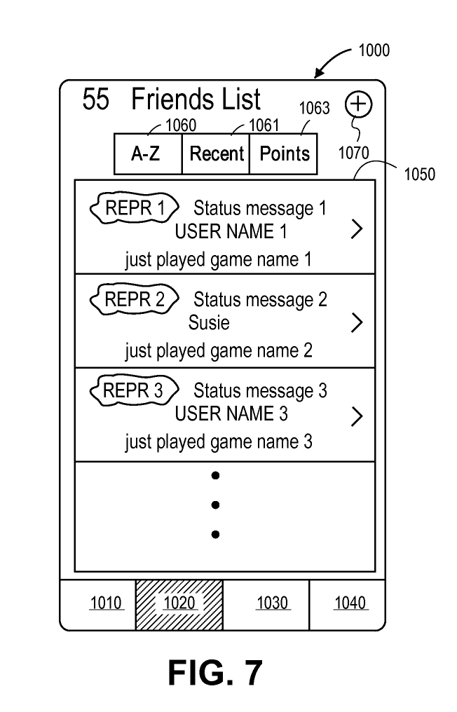

FIGS. 6A-6D, 7-10, 12-23, 28, and 29 illustrate exemplary user interfaces (e.g., graphical user interfaces (GUI)) provided by a game center module located on a client system in accordance with at least certain embodiments of the present disclosure. FIG. 6A illustrates an exemplary user interface 900 that is generated upon initiation of the game center module in one embodiment of the present invention. In one embodiment, option 910 is associated with a user profile, option 920 is associated with friends, option 930 is associated with gaming applications (e.g., games), and option 940 is associated with notifications.

FIG. 6B illustrates an exemplary user interface 925 that is generated upon selection of a profile option 910 in one embodiment of the present invention. For example, a user may select option 910 from an initial game center user interface 900 and the processing logic automatically generates and presents a user interface 925 illustrated in FIG. 6B having different profile options. These profile options may include generating/editing option 954 to generate a representation 950 (e.g., 2D avatar, 3D avatar) for the user (e.g., Mel), status message 952, and an account information option 956. The account information may relate to an account for account services 113.

FIG. 6C illustrates an exemplary user interface 960 having account information options in one embodiment of the present invention. The processing logic generates user interface 960 in response to a user selection of option 956. In one embodiment, option 956 displays a user's email address. This interface 960 includes password option 940, alias option 942, game invite option 944, and email option 946.

FIG. 6D illustrates an exemplary user interface 970 that is generated upon selection of a profile option 910 in one embodiment of the present invention. For example, a user may select option 910 from an initial game center user interface 900 and the processing logic automatically generates and presents a user interface 970 illustrated in FIG. 6D. The user interface 970 includes the user's name or user name (e.g., MEL), a number of gaming friends (e.g., 55), a number of games played by the user (e.g., 24), and a number of completed achievements (e.g., 23). The user interface 970 also includes a status message 978 that is set by the user.

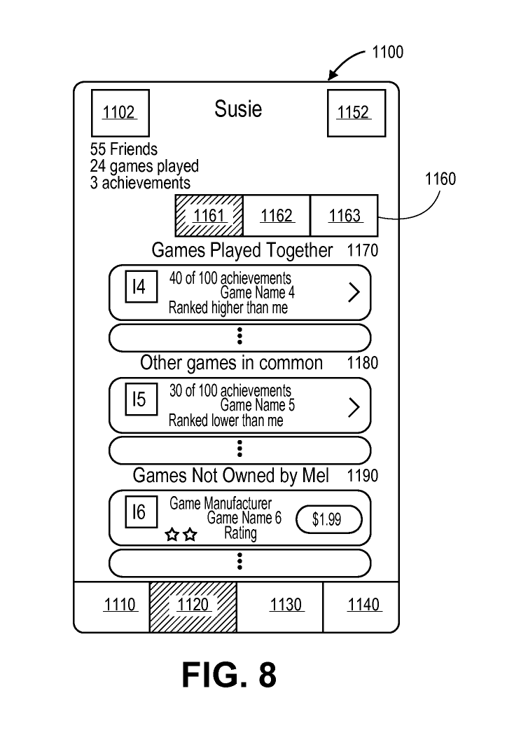

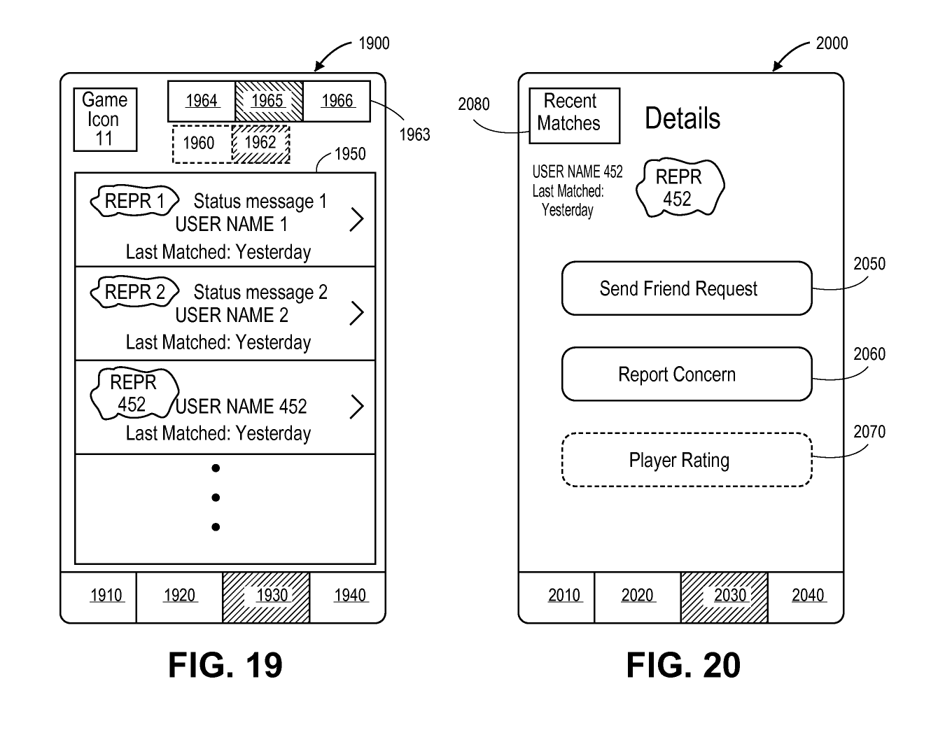

FIGS. 7 and 16 illustrate exemplary user interfaces 1000 and 1002 having a list of friends in one embodiment of the present invention. The user interface 1000 in FIG. 7 is generated in response to a user selection of the friends option (e.g., option 220). The list of friends 1050 can be ordered with categorization options 1060-1062 using various categories (e.g., alphabetic from A-Z, friends that have recently played games with the user, points from highest to lowest, etc.). Alternatively, one or more databases having friend information (e.g., email, name, nickname) can be searched to find a friend by name or nickname. Information for each friend (e.g., user name 1, Susie, user name 3) in the list of friends is displayed on the user interface 1000. This friend information includes user name, a status message provided by the friend (e.g., I just dominated this game), an optional representation (REPR) for the friend, and the game most recently played by the friend, etc. The representation may be an avatar for the friend. A user selection of option 1070 provides a list of the user's contacts and associated contact information (e.g., phone #, email address, URL, address, additional fields, etc.). A selection of points option 1062 in FIG. 7 causes the generation of user interface 1002 illustrated in FIG. 16. The friends have been ordered based on achievement points.

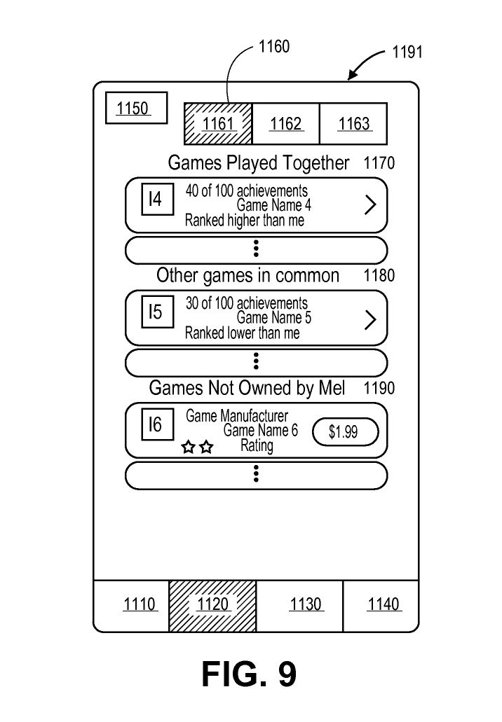

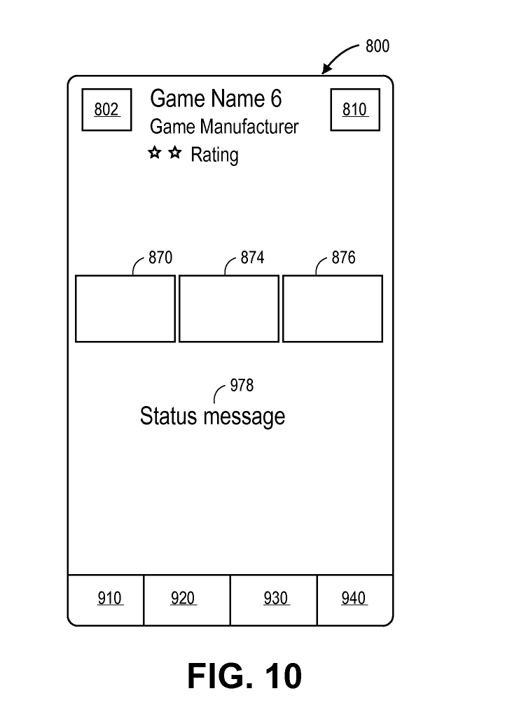

FIGS. 8 and 9 illustrate exemplary user interfaces having friend details of a particular friend and a navigation region with navigation options in one embodiment of the present invention. The user interface 1100, which is associated with a hub option, can be generated in response to a user selection of a friend from the list of friends 1050. In one embodiment, the friends details user interface 1100 is generated in response to the initial user selection of a friend from the list of friends 1050. The user interface 1100 includes header information near the top of the user interface. The navigation region 1160 is positioned near an upper region of the user interface and the data region has a larger region to enhance the user viewing experience.

The user interface 1100 include friend details for the selected friend including a user name (e.g., nickname, alias, name), a back option 1102, number of friends, number of games played, number of achievements, an optional representation (e.g., avatar, photo) 1152, and a navigation region 1160. This region 1160 includes options 1161-1163 for navigating the hierarchy. The navigation options provide access to different types of data buckets (e.g., leaderboard, comparison achievement data between the selected friend and user, achievement points, games of the selected friend, friends of the selected friend, developer group, etc.).

The games option 1161 may be automatically or by default selected for user interface 1100 based on the selection of Susie from the friend list of FIG. 7 or based on accessing the friend details user interface from the game details user interface. The selection of the games option 1161 causes the user interface 1100 to include a list 1170 of games played together between the friend (e.g., Susie) and the user, a list 1180 of other games in common between the friend and the user, and a list 1190 of games owned by the friend, but not owned by the user (e.g., Mel).

A subsequent selection of the games option 1161 may cause the generation of a user interface 1191 that is illustrated in FIG. 9, which displays games of Susie. The user interface 1191 is similar to user interface 1100 and also includes a list 1170 of games played together between the friend and the user, a list 1180 of other games in common between the friend and the user, and a list 1190 of games owned by the friend, but not owned by the user (e.g., Mel). The navigation region 1160 includes options 1161-1163 for navigating the hierarchy. The region 1160 has been moved towards the top of the user interface 1191 and header information has been removed to allow more data (e.g., games) to be displayed on the remainder of the display to enhance the user's navigation and viewing experience.

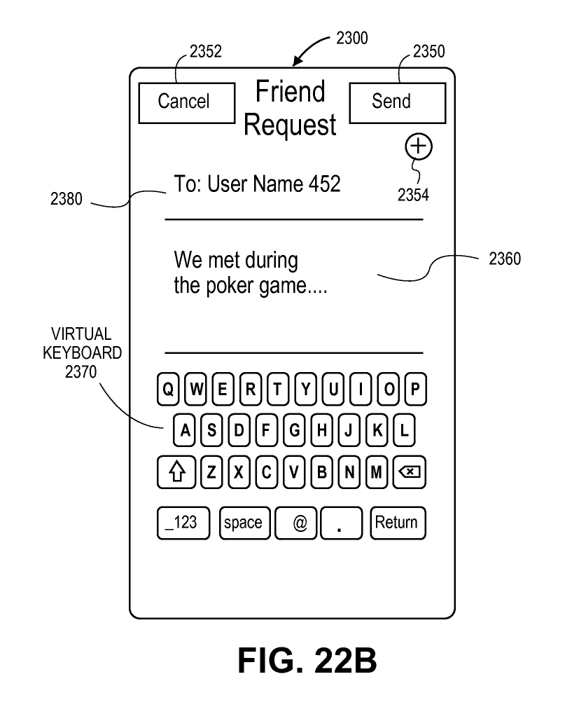

A user selection of a points option 1162 (e.g., option 1863 in FIG. 18) may cause the generation of a user interface 1850 of FIG. 18 having a comparison of points and/or achievements for the user and the selected friend for one or more games that the user and selected friend have played each other or have in common. Alternatively, the points option 1162 may be selected automatically or by default for a user that accesses the friend details user interface directly or indirectly from a leaderboard or achievement user interface. If a game does not have a default option available, then a next available option can be the default selection.

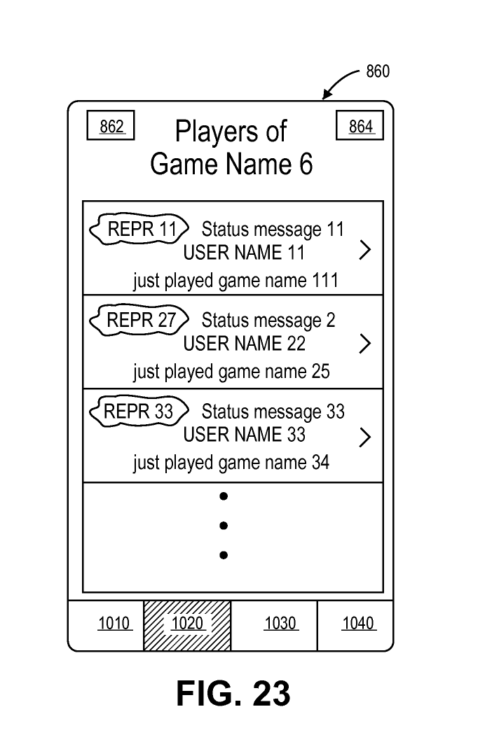

A selection of a friends of friends option 1163 may cause the generation of a user interface having a list of friends of the selected friend. In an alternative embodiment, a selection of a recent matches option may cause the generation of a user interface 1900 that is illustrated in FIG. 19. In one embodiment, switching between navigation options results in generating a user interface that maintains the ordering of objects and texture of the previous user interface, but switches data based on the selected navigation option and associated data bucket. The data associated with the selected navigation option may be listed starting from the beginning of a list.

As discussed above, the user interface 1191 includes a list 1170 of games played together between the friend and the user, a list 1180 of other games in common between the friend and the user, and a list 1190 of games owned by the friend, but not owned by the user (e.g., Mel). For each game played together, the list 1170 may include a game icon (e.g., 14), achievements of the friend for the particular game, the name of the game, and a comparison of how the friend and the user rank on the leaderboard (e.g., ranked higher than me, ranked waaaaaaaay higher than me, ranked about the same as me) for a particular game. For example, the friend is ranked higher than the user for game name 4 displayed in the list 1170.

In certain embodiments, the user and friends rankings are compared to each other and displayed. For example, for game name 4 the friend may be ranked in the 47^{th} percentile and the user is ranked in the 49^{th} percentile. In this case, the friend and the user are ranked about the same. In another embodiment, the friend is ranked first and the user is ranked last for the game name 4. In this case, the friend is ranked waaaaaaaay higher than me.

For each game in common, the list 1180 may include a game icon (e.g., 15), achievements of the friend for the particular game, the name of the game, and a comparison of how the friend and the user rank on the leaderboard (e.g., “ranked higher than me”) for a particular game. For example, the friend is ranked lower than the user for game name 5 displayed in the list 1180.

For each game owned by the friend and not owned by the user (e.g., Mel), the list 1190 may include a game icon (e.g., 16), the game manufacturer of the particular game, the name of the game, a rating for a particular game (e.g., 2 out of 5 stars), and a cost of purchasing the particular game. For example, game name 6 has a two star rating and costs $1.99 to purchase from an online application store.

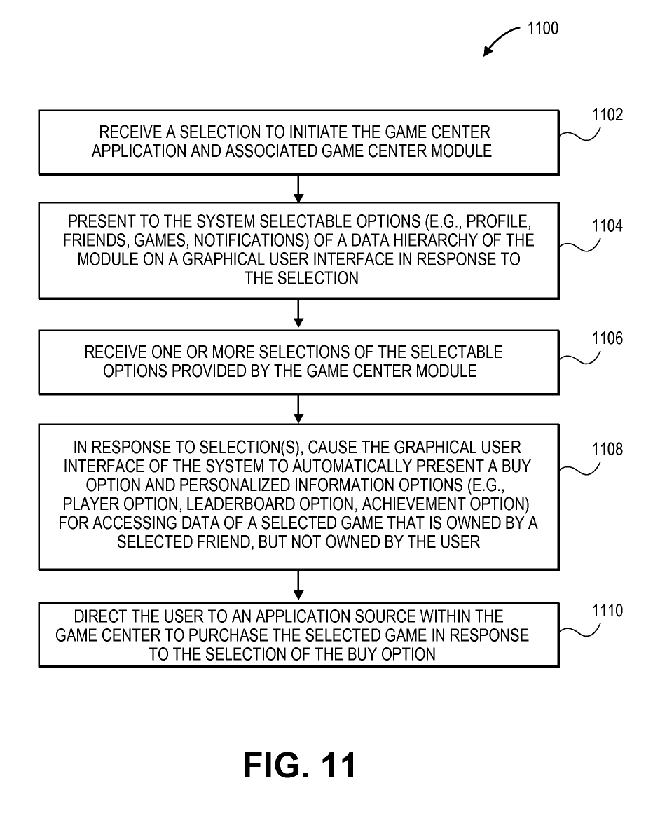

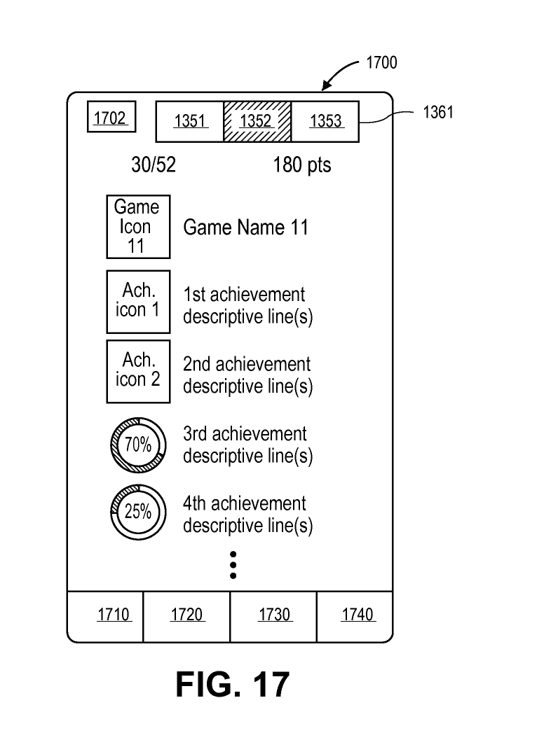

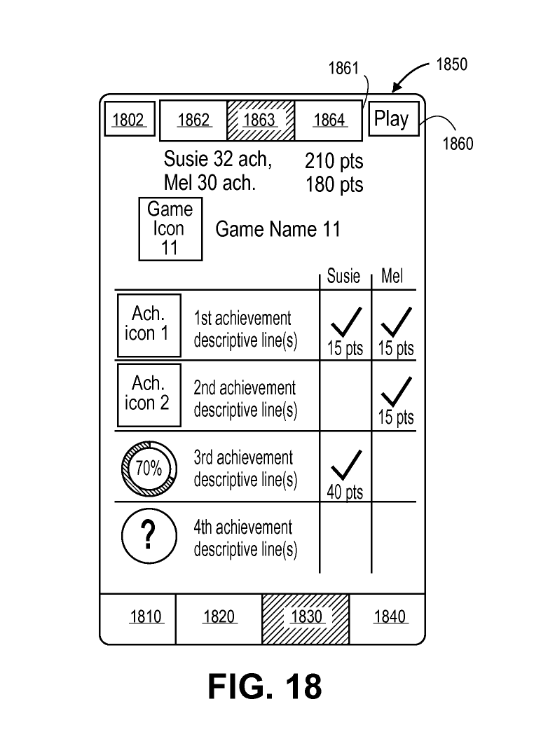

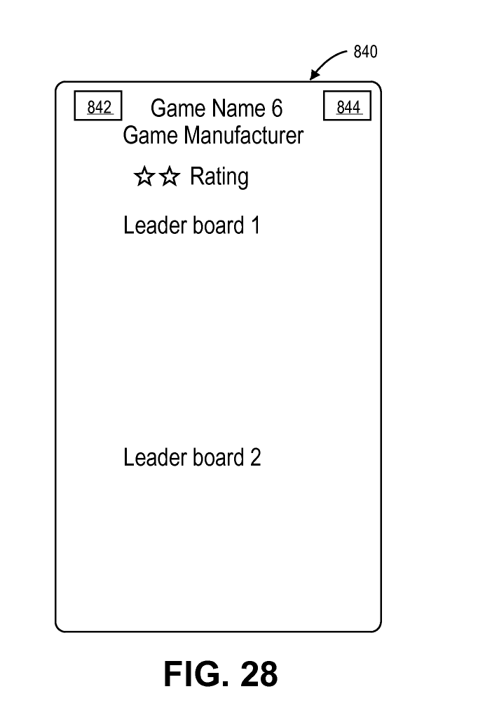

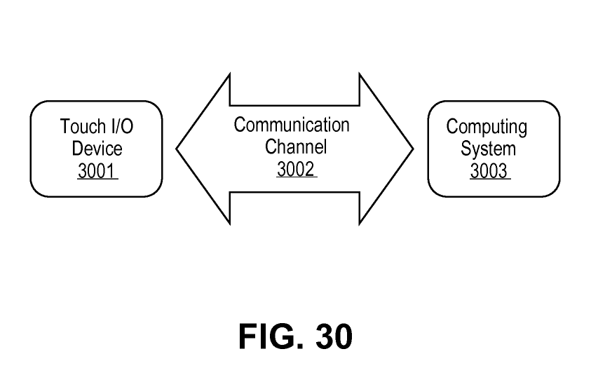

The processing logic generates user interface 800 of FIG. 10 in response to a selection of one of the games (e.g., game name 6) that is not owned by the user as displayed on user interface 1191. The user interface 800 provides a buy option 810 to access an online application store (e.g., application service 114) user interface within the game center or to access game center's user interface to purchase the selected game in response to the user selection of one of these games (e.g., game name 6). The user interface 800 includes personalized information options 870, 874, and 876 for the selected game that is not owned by the user. The personalized information for the user can include information about the selected game that is owned by the selected friend or friends of the selected friend. The information could be based on data related to the user's friends, friends of friends, and/or the user. The personalized options may include personalized option 870 to provide a user interface 860 of FIG. 23 having a list of players that own the game upon selection of the option 870. The user interface 860 includes a back option 862 and a buy option 864. The option 874 provides a user interface 840 of FIG. 28 having one or more leaderboards for the selected friend for the game upon selection of the option 874. The leaderboards may be any type of leaderboard appropriate for displaying the performance or ranking of the selected friend that owns the game and other friends or players of the game. In one embodiment, the leaderboards may be similar to the exemplary leaderboards illustrated in FIGS. 14 and 15, except that Mel will not be included in the leaderboards because Mel does not own the game. The user interface 840 includes a back option 842 and a buy option 844. The option 876 provides a user interface 880 of FIG. 29 having achievement data for the selected friend for the game upon selection of the option 876. The user interface 880 includes a back option 882 and a buy option 884. In one embodiment, the user interfaces provided by the personalized options each include a buy option.

In another embodiment, the user interfaces provided by the personalized options each include a navigation region with personalized information options 870, 874, and 876 for navigating between these different options. In this case, a default option may be automatically selected and associated data displayed on the user interface 800 depending on how a user accesses the user interface 800. The user interface 800 may display a graphical icon for the game, a game manufacturer for the game, a game name, a rating for the game, and a price for purchasing the game. The user interface 800 also includes a back option 802 to return to a previous user interface.

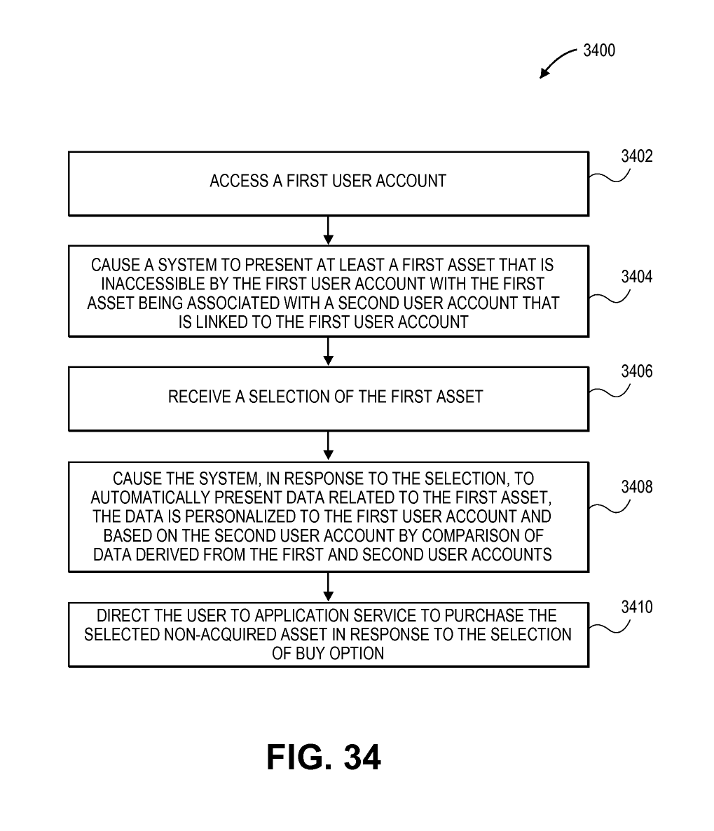

FIG. 34 illustrates a flow diagram in one embodiment of the present invention for a computer-implemented method 3400 of providing personalized information for a non-acquired asset. The computer-implemented method 3400 is performed by processing logic that may comprise hardware (circuitry, dedicated logic, etc.), software (such as is run on a general purpose computer system or a dedicated machine or a system), or a combination of both. In one embodiment, the computer-implemented method 3400 is performed with a client system.

At block 3402, the processing logic accesses a first user account. At block 3404, the processing logic causes a system to present at least a first asset that is inaccessible by the first user account. The first asset may be associated with a second user account that is linked to the first user account. At block 3406, the processing logic receives a selection of the first asset. At block 3408, the processing logic, in response to the selection, causes the system to automatically present data related to the first asset. The data may be personalized to the first user account and based on the second user account. The data may be personalized to the first user account and based on the second user account by comparison of data derived from the first and second user accounts. In one embodiment, the first user account and the second user account may be associated with the user. In another embodiment, the first user account is associated with the user and the second user account is associated with a friend of the user. In an alternative embodiment, the first asset is associated with a third user account that is linked to the second user account. The data is personalized to the first user account and based on the second and third user accounts by comparison of data derived from the first, second, and third user accounts. The first user account may be associated with the user, the second user account may be associated with a friend of the user, and the third user account may be associated with a friend of the friend of the user. In an embodiment, data is personalized to the first user account and based on the friend user accounts and/or friend of friend user accounts by comparison of data derived from the user account, friend accounts, and friend of friend accounts.

The non-acquired asset (e.g., media, item or content for a software application or collaborative application (e.g., document creation, music creation, games)) may be owned by a friend, contact, or player, but not owned or accessible to the user. The personalized data allows a user to learn information regarding one or more non-acquired assets from the user's friends, contacts, players, friends of friends, contacts of contacts, etc. without owning or having access to the non-acquired asset. The user can decide whether to obtain or purchase the non-acquired based on this personalized information. The user may be a parent that can review information regarding one or more non-acquired assets being accessed by a child. The parent can use the personalized information to monitor the one or more non-acquired assets being accessed by the child.

At block 3410, the processing logic automatically directs the user to an application service to purchase the selected non-acquired asset in response to the selection of a buy option.

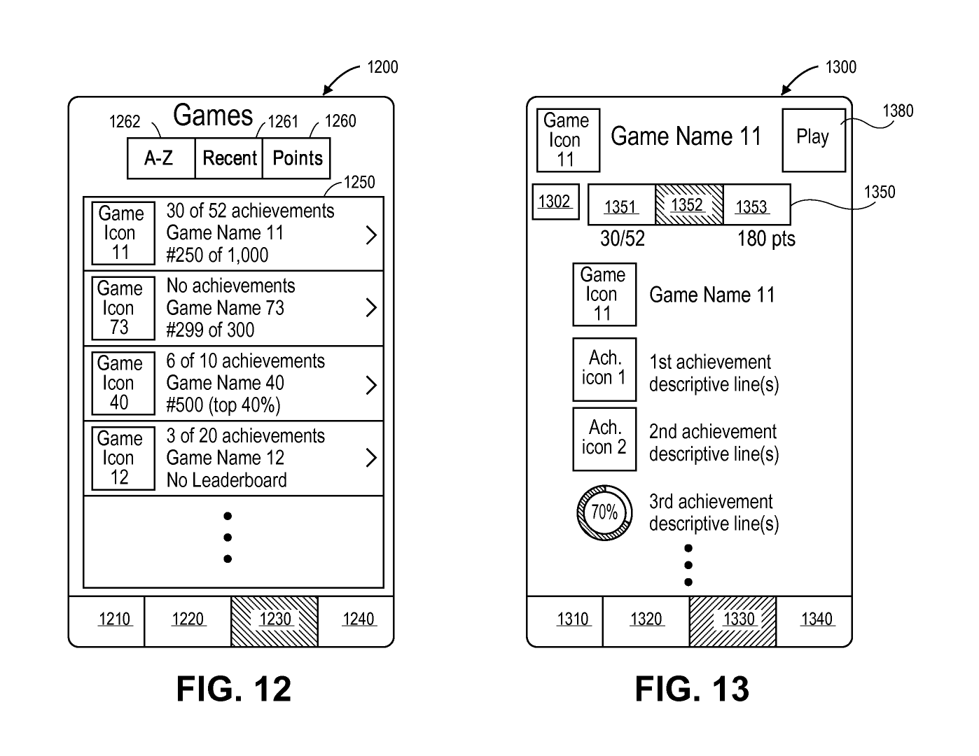

FIG. 11 illustrates a flow diagram in one embodiment of the present invention for a computer-implemented method 1100 of providing personalized information for a non-acquired asset. For example, the method may provide personalized information for a software application (e.g., game) that is not owned by a user on a client system. The computer-implemented method 1100 is performed by processing logic that may comprise hardware (circuitry, dedicated logic, etc.), software (such as is run on a general purpose computer system or a dedicated machine or a system), or a combination of both. In one embodiment, the computer-implemented method 1100 is performed by the module 200 (e.g., game center module) located on a client system.

At block 1102, the processing logic receives a selection to initiate the game center application and associated game center module. At block 1104, the processing logic can present to the system selectable options (e.g., profile, friends, games, notifications) of a data hierarchy of the module on a graphical user interface in response to the selection. At block 1106, the processing logic may receive a selection of the selectable options provided by the game center module. For example, the processing logic may receive a user selection of friends option 220, friends list option 222, select a friend from the list of friends, and then select a game from a list games that are not owned by the user. At block 1108, the processing logic, in response to selection(s), causes the graphical user interface of the system to automatically present a buy option and personalized information options (e.g., player option, leaderboard option, achievement option) for accessing data of a selected game that is owned by the selected friend, but not owned by the user. The personalized options further include a first personalized option to provide a list of players that own the game upon selection of the first personalized data option. The list of players may include all players of the game, friends of the selected friend that play the game, or players that have played the game with the selected friend. A second personalized option provides one or more leaderboards for the selected friend for the game upon selection of the second personalized option. A third personalized option provides achievement data for the selected friend for the game upon selection of the third personalized option. The personalized options allow a user to learn information regarding a game from the user's friend or friends of friends without owning the game. The user can the decide whether to purchase the game based on this personalized information. The user may be a parent that can review information regarding one or more games being played by a child. The parent can use the personalized information to monitor the one or more games being played by the child.

At block 1110, the processing logic automatically directs the user to an application service within the game center to purchase the selected game in response to the selection of the buy option.

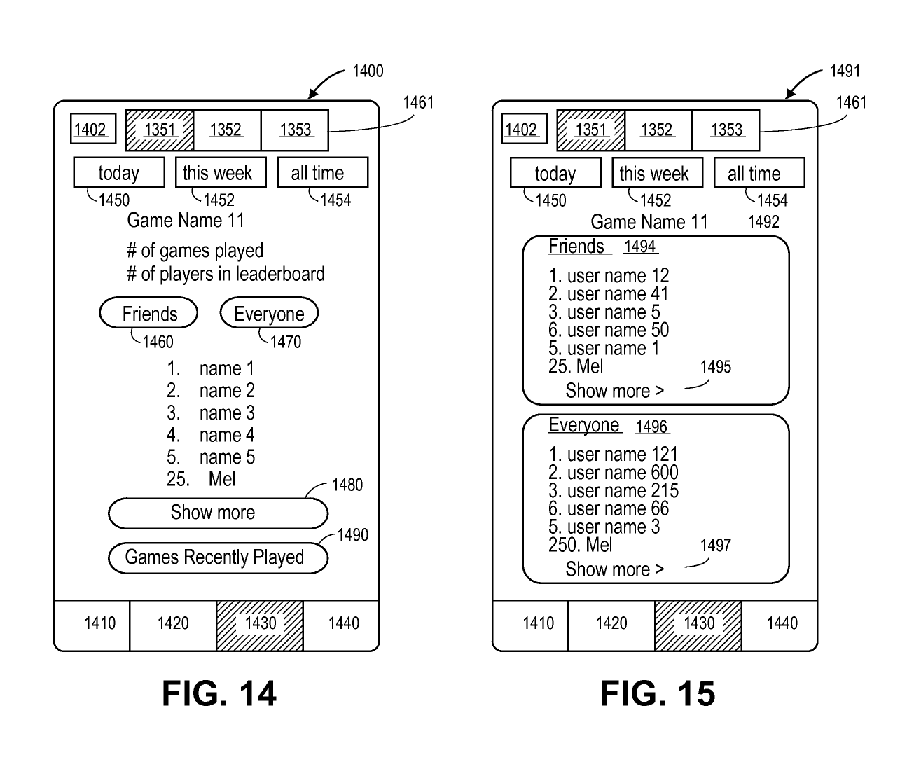

FIG. 12 illustrates an exemplary user interface 1200 having a list of games 1250 in one embodiment of the present invention. The user interface 1200 is generated in response to a user selection of the games option (e.g., option 1161). The list of games 1250 can be ordered alphabetically (e.g., A-Z option 1262), in order of most recently played (e.g., recent games option 1261), or in order of points (e.g., points option 1260). In an embodiment, the list of games 1250 still includes a particular game even if the user deletes the particular game from the system.

Information for each game in the list of games is displayed on the user interface 1200. This game information includes game icon, user achievements for this game, game name, and ranking for the user playing this game. For example, game name 11 is displayed with game icon 11. The user has 30 of 52 achievements and ranks 250^{th} out of 1,000 players. Alternatively, the ranking for the user can be a ranking among the user's friends rather than a ranking among everyone.

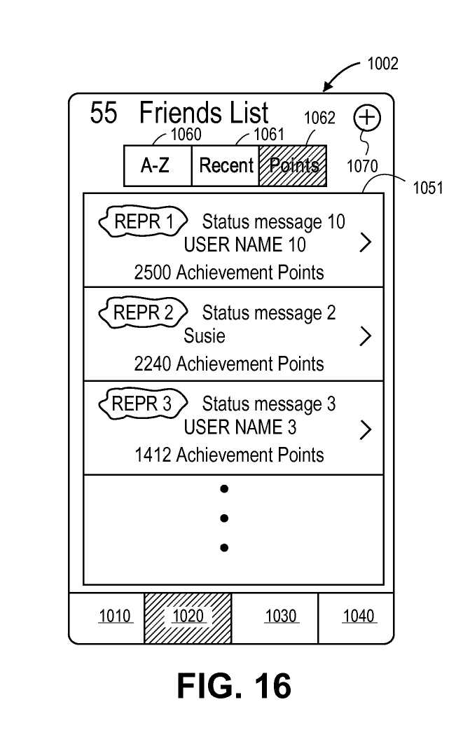

FIGS. 13-15 illustrate exemplary user interfaces 1300, 1400, and 1491 associated with a hub option having gaming details of a particular game in one embodiment of the present invention. The user interface 1300 is generated with option 1353 being selected automatically in response to a user selection of a game (e.g., game name 11) from the list of games 1250 that have been categorized based on points. The user interface 1300 includes achievement and point data for Game Name 11. The user interface 1400 is generated with leaderboard option 1351 being selected automatically in response to a user selection of a game (e.g., game name 11) from the list of games 1250 or from an option of the friend details hub (e.g., games of friend option from friend details user interface) being accessed prior to accessing the game details user interface 1400. In one embodiment, option 1351 is a default automatic selection for the game details user interface. In another embodiment, user interface 1491 of FIG. 15 is generated rather than user interface 1400. User interface 1491 is similar to user interface 1400, but has a different arrangement for the leaderboard.

The user interface 1300 includes details for the selected game including a game icon, navigation region 1350 with navigation options 1351-1353 (e.g, a leaderboard option 1351, a selected achievement option 1352, a players option 1353, developers group, etc.). The user interface 1300 also includes a play option 1380. A selection of the option 1380 causes the game (e.g., game name 11) to be played. Alternatively, if the user does not have this particular game (e.g., game name 11), then the play option 1380 is replaced with a buy option from the game center or from access to the application store from within the game center or the play option 1380 could be replaced with a get it option that downloads the game from the application store or another location.

User interface 1400 is a leaderboard that includes the previously selected game name (e.g., game name 11), a number of games played by the user, a number of players in the leaderboard, and at least a partial list of the leaderboard. The user interface 1400 includes a today option 1450, a this week option 1452, an all time option 1454, a friends options 1460, and an everyone option 1470. The list of leaders can be filtered and ranked based on these options. The user interface 1400 includes a navigation region 1461 with navigation options 1351-1353 (e.g, a leaderboard option 1351, an achievement option 1352, a players option 1353, developers group, etc.).

Alternatively, a selection of the option 1351 causes the processing logic to generate user interface 1491 as illustrated in FIG. 15 in accordance with one embodiment. User interface 1491 includes a selectable leaderboard option 1492 to select among different leaderboards (e.g., leaderboard 1, leaderboard 2, etc.). For example, Game Name 11 may include 4 different tracks that are not related to each. A different leaderboard can be generated for each track. A merged leaderboard may include rankings aggregated from all tracks. The user interface 1491 includes a today option 1450, a this week option 1452, and an all time option 1454. The list of leaders can be filtered and ranked based on these options.

Friends 1494 includes a ranked list of Mel's friends for Game Name 11. Everyone 1496 includes a ranked list of all users for Game Name 11.

In certain embodiments, a certain number of top players are listed (e.g., five) and if the user (e.g., Mel) is not in this list, then the user's ranking is also listed (e.g., 25th). A show more option (e.g., 1495, 1497) can be selected to display additional player rankings. Optionally, a games recently played option 1490 can filter the rankings to show rankings of the players that played in the most recent games (e.g., 10 most recent games). Different types of metrics can be defined for creating the rankings in the leaderboard. For example, the metrics may include points, number of top finishes, number of finishes within a certain threshold, etc. A game developer can define these metrics and the leaderboard. The user interfaces (e.g., 1400, 1491) may be presented as a smaller snapshot during a game for convenience of the users. The leaderboard presented during a game may have selectable or non-selectable options during the game.

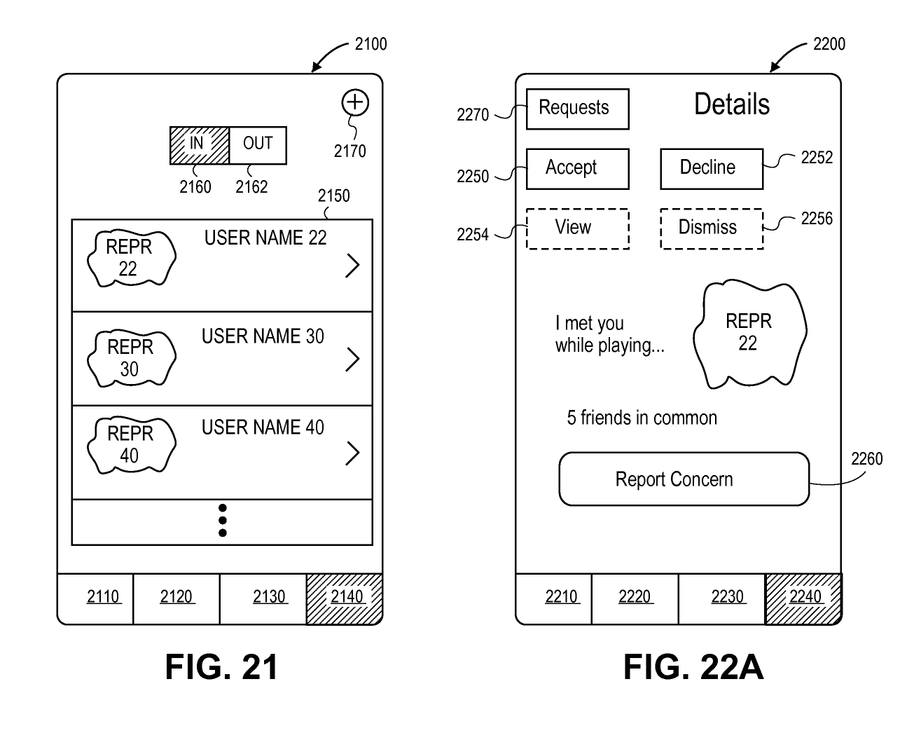

Returning to FIG. 13, a subsequent selection of the option 1352 causes the processing logic to generate user interface 1700 as illustrated in FIG. 17 in one embodiment of the present invention. The user interface 1700 includes a navigation region 1361 with navigation options 1351-1353 (e.g, a leaderboard option 1351, a selected achievement option 1352, a players option 1353, developers group, etc.), which has been moved towards the top of the user interface while header information has been removed in order to display more achievement data below the navigation region 1361.

User interface 1700 includes achievements for the user with respect to the selected game (e.g., game name 11). The achievements include a score based on a number of achievements completed by the user (e.g., 30/52 and a resulting score of 180 points). The user interface 1700 includes a list of achievements. Each achievement has a name, descriptive lines, and an icon if the user has completed the achievement. Otherwise, the icon is replaced with progress information that indicates a current amount of progress toward completing the achievement (e.g., 70%, 30%). The icon may include a question mark (?) if the user has not made any progress towards completing the achievement or less than a certain threshold of progress. The user interface 1700 includes a back option 1702 for returning to a previous user interface.

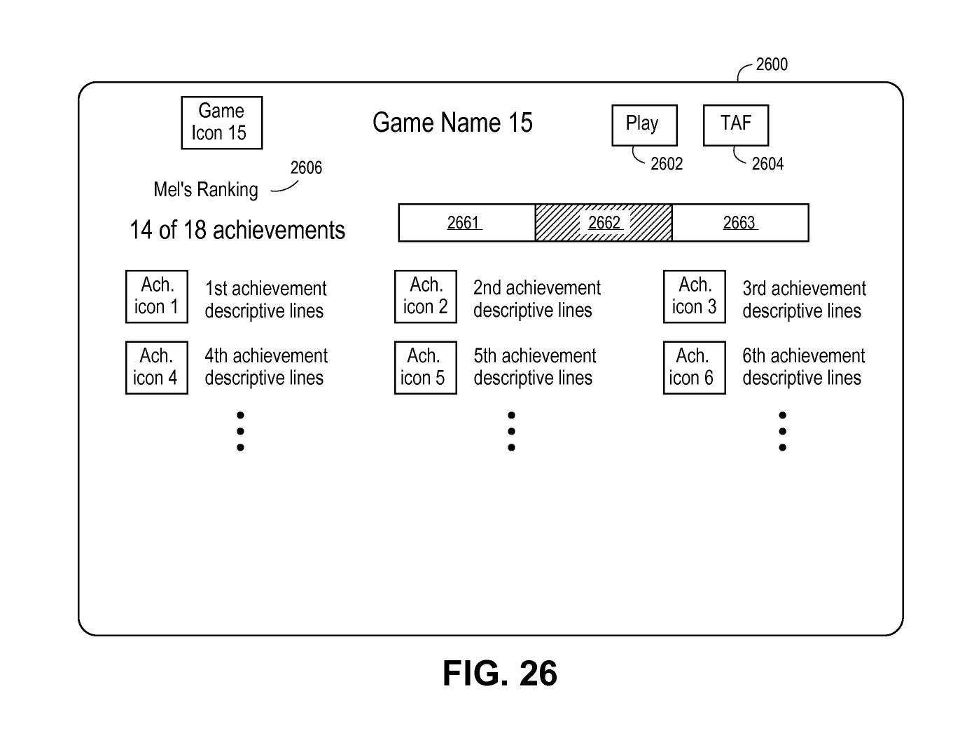

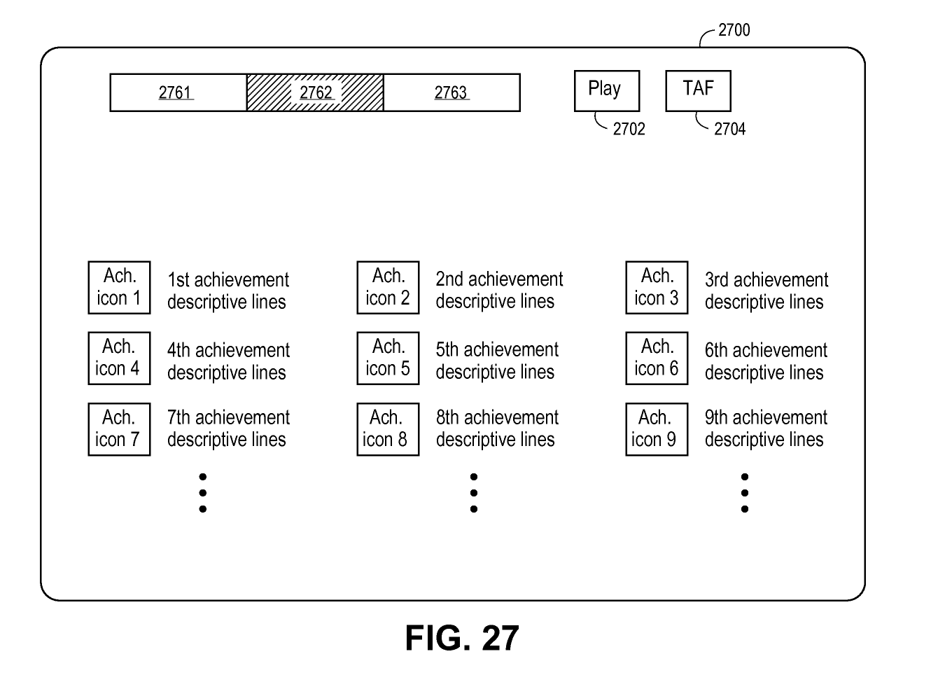

Returning to FIG. 13, a selection of the player option 1353 causes the processing logic to generate a user interface with a list of players for the selected game (e.g., game name 11). This user interface may be similar to the user interface 860 of FIG. 23. A selection of a friend from the list of players causes the processing logic to return to the friend hub (e.g., friend details user interface) and generate user interface 1100 in one embodiment. The list of players can be separated in friends and non-friends of the user. A selection of a non-friend from the list of players causes the processing logic to generate a send friend request communication as illustrated in FIG. 22B with user interface 2300 to invite the player to become a friend. The friend request being sent from the user to the non-friend may include a number of friends in common between the user and the non-friend. This may increase the likelihood that the non-friend will accept the friend request.

In one embodiment, the user interface 2300 includes a send option 2350 to send the friend request communication to a player, a cancel option 2352 to cancel the communication, a To field 2380 that displays the selected player's user name and is associated with an email address, a text field 2360 for composing a message, and a virtual keyboard 2370. The user interface 2300 may represent an email message. A user selection of the send option 2350 causes an alert message to appear on a graphical user interface of the system in one embodiment of the present invention. The alert message indicates that the friend request has been sent and the friend will be added to the user's friend list upon acceptance.

In an embodiment, the To field 2380 is prefilled with a user name based on a previous user selection (e.g., selection of option 2050). Alternatively, a user can enter contact information (e.g., name, nickname, alias, email address, phone number) into the field 2380. In another embodiment, a user can select option 2354 and search for contact information for a player to invite from the user's contacts or address book. The user may be able to determine from the contact information whether a particular player is registered with the game service associated with the game center module.

After a user selects the send option 2350, a server associated with the game service receives the contact information in the field 2380. If the contact information is an email address, then the server uses the email address to find a matching email in email accounts registered with the game service or account service. The recipient of the friend request then receives a push notification that appears in the game center module associated with the recipient. If the contact information is not an email address (e.g., alias), then an email address for the recipient can be found using the contact information if the recipient is registered with the game service. Otherwise, if the recipient is not registered with the game service, then an external social network (e.g., Facebook, Twitter) can be searched to find an email address for the recipient. For example, Facebook data can be obtained for the recipient and an email sent to Facebook with this email requesting the email address of the recipient.

In one embodiment, the recipient has a client system (e.g., Apple iPod Touch®, Apple iPhone®, Apple iPad®) and an account with the game service. Upon receipt of the friend request, the game center module of the recipient is launched and the recipient can accept the friend request.

In an embodiment, the recipient has the client system, but does not have an account with the game service. Upon receipt of the friend request, the game center module of the recipient is launched and the recipient receives a recommendation to join the game service associated with the game center module. In another embodiment, the recipient does not have a client system. In this case, the recipient receives the email message and can be directed to web page to join the game service.

In an alternative embodiment, a selection of a recent matches option of a navigation region from a game details user interface or friend details user interface causes the processing logic to generate user interface 1900 as illustrated in FIG. 19 in one embodiment of the present invention. The user interface 1900 includes a navigation region 1963 with navigation options 1964-1966 (e.g., a leaderboard option, a players option, games option, an achievements option, recent matches option 1965, etc.). The user interface 1900 includes a list of players 1950 from recent games with the user. For example, all players from the 10 most recent matches with the user can be displayed. The list 1950 may include only friends or all players based on the selection of friend option 1960 or all player option 1962. More information can be shared for friends compared to non-friends. For example, the shared gaming information for each friend of the user may include a name, a status message, a representation (e.g., avatar), and session data (e.g., date of last match with the user). The shared gaming information for each non-friend of the user may include a name, a representation (e.g., avatar), and session data. In an embodiment, session data is obtained from a server. In another embodiment, session data is not shared for friends or non-friends. Each player in the list of players is associated with a selectable option.

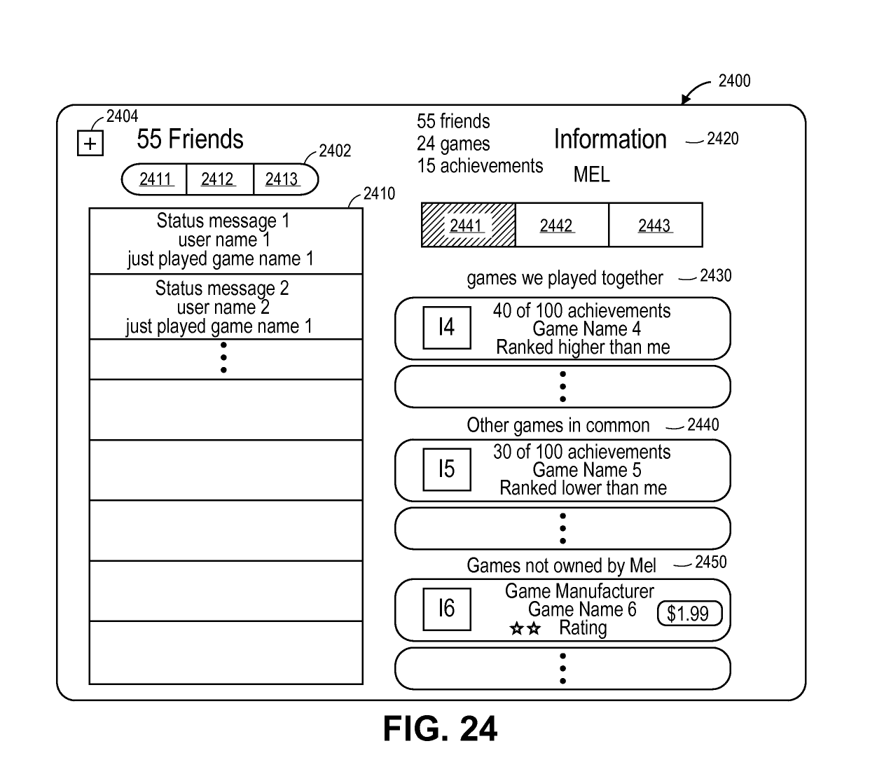

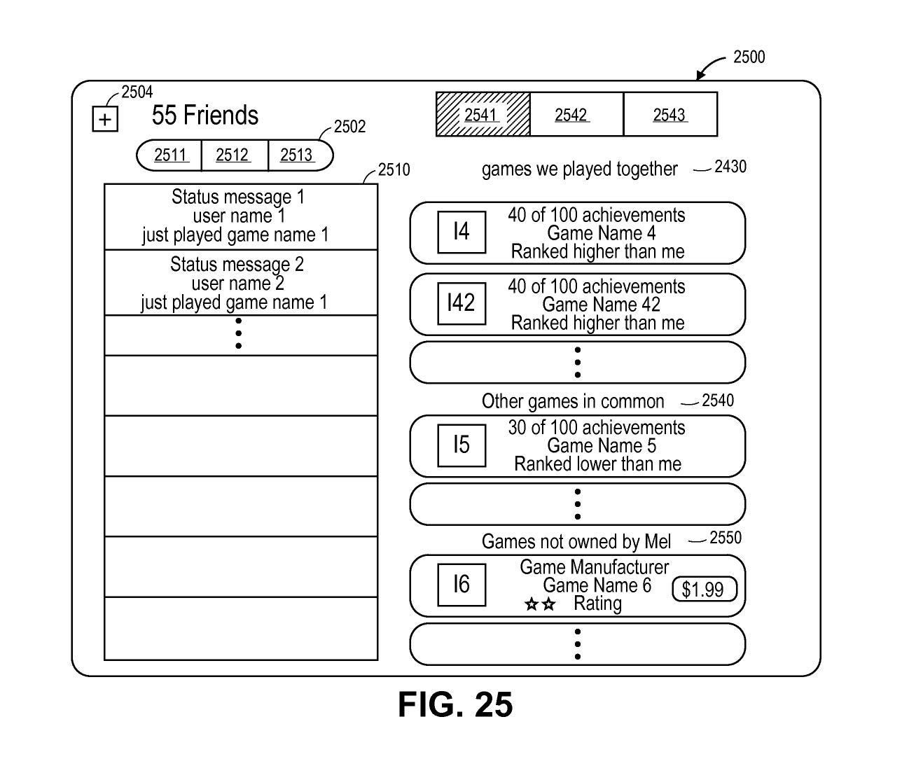

A selection of a player that is already a friend causes the processing logic to generate user interface 1100 for the selected friend. A selection of a player that is not a friend causes the processing logic to generate user interface 2000 as illustrated in FIG. 20 in one embodiment of the present invention in order to invite this player to become a friend. User interface 2000 may include a name, a representation (e.g., avatar), and session data for the selected non-friend. Send friend request option 2050 can be selected to generate a user interface having a friend request communication or this request can be added to an exemplary user interface having a list of requests as illustrated in FIG. 21 and discussed in more detail below. Alternatively, a concern can be reported regarding this selected player by selecting option 2060 from user interface 2000. Optionally, user interface 2000 may also include a player rating option 2070. The user can provide a rating for the player that was recently matched with the user. Selection of option 2080 causes the generation of the previous user interface 1900.

The game center module and game service provide a game center in which a user can send and receive notifications (e.g., friend requests, game invitations, game updates, etc). FIGS. 21, 22A, 22B, and 23 illustrate exemplary user interfaces for friend requests.

FIG. 21 illustrates an exemplary user interface 2100 having a list of notifications (e.g., friend requests, updates) in one embodiment of the present invention. A user selection of a notification option 2140 generates a user interface 2100 as illustrated in FIG. 21. The user interface 2100 includes a list of notifications 2150 received or sent by a user. A selection of option 2160 causes the processing logic to generate a list of notifications (e.g., friend requests, updates) received while a selection of option 2162 causes the processing logic to generate a list of notifications (friend requests, updates) sent. A user selection of option 2170 provides a list of the user's contacts and associated contact information (e.g., phone #, email address, URL, address, additional fields, etc.).

In an embodiment, an incoming friend request may be associated with an email address. The user's address book or contact information associated with the user's contacts can be searched to find a match with the email address. If a match occurs, then the incoming friend request will display a real name or nickname for the player who sent the incoming friend request to the user.

In one embodiment, option 2160 is selected and then user name 22 is also selected. FIG. 22A illustrates an exemplary user interface 2200 having a received friend request in one embodiment of the present invention. User interface 2200 is generated in response to the selection of user name 22 from the list 2150. The user interface 2200 includes details regarding the player that sent the friend request such as a representation (e.g., avatar), a short message from this player, and optionally a number of friends in common between the user and the player that sent the friend request. The user interface 2200 also includes accept option 2250 to accept a request, decline option 2252 to decline a request, optional view option 2254 to view more details regarding the request, and an optional dismiss option 2256 to dismiss the friend request and possibly block future requests from the same player for a certain time period or indefinitely.

In an embodiment, user interface 2200 includes options 2250, 2252, 2254, and 2256. In certain embodiments, options 2254 and 2256 are both not included or only one of these options is not included. In certain embodiments, various combinations of these options are possible. Options may also be provided that permit a user to defriend a current friend, decline a friend request once and never receive another invite from this player, or limit friend requests in time (e.g., 1 invite/week).

The user interface 2200 also includes a report concern option 2260 to report a concern regarding the player that sent the invitation. A user selection of the request option 2270 causes the generation of the user interface 2100.

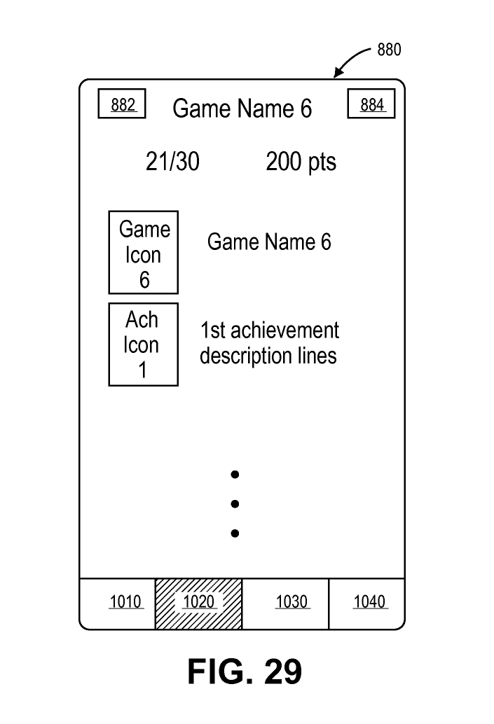

FIGS. 24-27 illustrate exemplary user interfaces designed for systems with larger displays in one embodiment of the present invention. For example, these systems may include any system or device having a display larger than a display of a mobile phone device. FIG. 24 illustrates a user interface 2400 with a searchable list of friends and additional information in accordance with one embodiment. User interface 2400 includes content similar to that of the user interfaces illustrated in FIGS. 7 and 9. The user interface 2400 includes a list of friends 2410. The list of friends 2410 can be ordered with seach option 2402 that includes categorization options 2411-2413 using various categories (e.g., alphabetic from A-Z, recently played games, points from highest to lowest, etc.). A user selection of option 2404 provides a list of the user's contacts and associated contact information (e.g., phone #, email address, URL, address, additional fields, etc.).

The navigation region includes options 2441-2443 for navigating the hierarchy. The navigation options provide access to different types of data buckets (e.g., leaderboard, comparison achievement data between the selected friend and user, achievement points, games of the selected friend, friends of the selected friend, developer group, etc.).

A selection of a games option 2441 is illustrated in FIG. 24, which displays games of Susie. The games option 2441 may be automatically or by default selected for user interface 2400 based on the selection of Susie from the friend list or based on accessing the friend details user interface from the game details user interface. The user interface 2400 also include a list 2430 of games played together between the friend and the user, a list 2440 of other games in common between the friend and the user, and a list 2450 of games owned by the friend, but not owned by the user (e.g., Mel).

A selection of a points option 2442 may cause the generation of a user interface having a comparison of points for the user and the selected friend for one or more games that the user and selected friend have played each other or have in common. A selection of a friends of friends option 2443 may cause the generation of a user interface having a list of friends of the selected friend.

The user interface 2400 also includes information 2420, which includes a user's name (e.g., Mel), a number of friends, a number of games played, and a number of achievements.

FIG. 25 illustrates a user interface 2500 with a searchable list of friends and additional information in accordance with one embodiment. User interface 2500 includes content similar to that of the user interface 2400, except that information 2420 has been removed and the navigation region has been moved towards the top of the user interface to create a large region for data. User interface 2500 may be generated for a subsequent selection of option 2541. User interface 2500 includes a search option 2502 and a list of friends 2510. The list of friends 2510 can be ordered with categorization options 2511-2513 using various categories (e.g., alphabetic from A-Z, recently played games, points from highest to lowest, etc.). A user selection of option 2504 provides a list of the user's contacts and associated contact information (e.g., phone #, email address, URL, address, additional fields, etc.).

The navigation region includes options 2541-2543 for navigating the hierarchy. The navigation options provide access to different types of data buckets (e.g., leaderboard, comparison achievement data between the selected friend and user, achievement points, games of the selected friend, friends of the selected friend, developer group, etc.).

FIG. 26 illustrates a user interface 2600 with achievement information for a particular game in accordance with one embodiment. The user interface 2600 includes a navigation region with navigation options 2661-2663 (e.g, a leaderboard option 2661, a selected achievement option 2662, a players option 2663, developers group, etc.).

The user interface 2600 includes a game name, a play option 2602, a tell a friend option 2604, a ranking 2606 for the game, a number of achievements for the game, and achievements (e.g., 18 achievements) for the game.

FIG. 27 illustrates a user interface 2700 with achievement information for a particular game in accordance with one embodiment. The user interface 2700 includes a navigation region with navigation options 2761-2763 (e.g, a leaderboard option 2761, an achievement option 2762, a players option 2763, developers group, etc.). The navigation region has been shifted towards the top of the user interface and the header information (e.g., game name 15, game icon 15, mel's ranking) has been removed in comparison with user interface 2600. This creates more display area for the achievement data and enhances the user's ability to interact with the user interface.

The user interface 2700 includes a game name, a play option 2702, a tell a friend option 2704, a ranking 2706 for the game, a number of achievements for the game, and achievements (e.g., 18 achievements) for the game.

In an alternative embodiment, the user interfaces illustrated in FIGS. 24-27 may also be used in mobile phone devices.

The user interfaces discussed in the present disclosure are merely examples. Other variations and modifications are within the scope of the present disclosure. For example, some user interfaces have been shown with four options (e.g., profile option, friend option, games option, notifications option) near the bottom of the user interfaces. These options can be located in other locations on the user interfaces or not displayed at all.

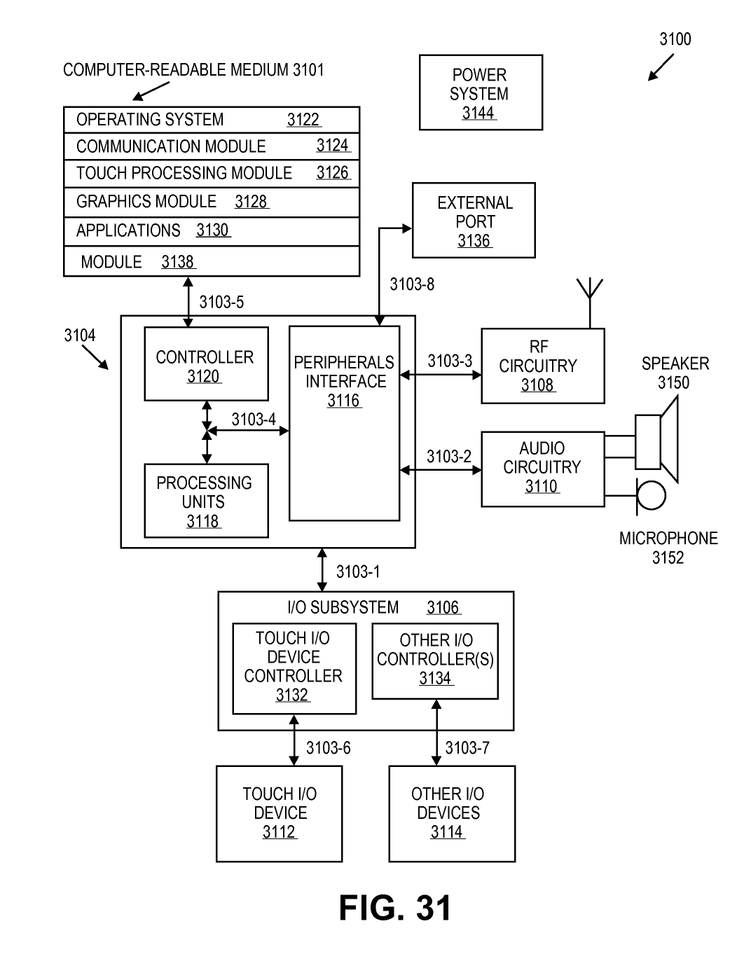

Described embodiments may include touch I/O device 3001 that can receive touch input for interacting with computing system 3003 as illustrated in FIG. 30 via wired or wireless communication channel 3002 in one embodiment of the present invention. Touch I/O device 3001 may be used to provide user input to computing system 3003 in lieu of or in combination with other input devices such as a keyboard, mouse, etc. One or more touch I/O devices 3001 may be used for providing user input to computing system 3003. Touch I/O device 3001 may be an integral part of computing system 3003 (e.g., touch screen on a laptop) or may be separate from computing system 3003.

Touch I/O device 3001 may include a touch sensitive panel which is wholly or partially transparent, semitransparent, non-transparent, opaque or any combination thereof. Touch I/O device 3001 may be embodied as a touch screen, touch pad, a touch screen functioning as a touch pad (e.g., a touch screen replacing the touchpad of a laptop), a touch screen or touchpad combined or incorporated with any other input device (e.g., a touch screen or touchpad disposed on a keyboard) or any multi-dimensional object having a touch sensitive surface for receiving touch input.

In one example, touch I/O device 3001 embodied as a touch screen may include a transparent and/or semitransparent touch sensitive panel partially or wholly positioned over at least a portion of a display. According to this embodiment, touch I/O device 3001 functions to display graphical data transmitted from computing system 3003 (and/or another source) and also functions to receive user input. In other embodiments, touch I/O device 3001 may be embodied as an integrated touch screen where touch sensitive components/devices are integral with display components/devices. In still other embodiments a touch screen may be used as a supplemental or additional display screen for displaying supplemental or the same graphical data as a primary display and to receive touch input.

Touch I/O device 3001 may be configured to detect the location of one or more touches or near touches on device 3001 based on capacitive, resistive, optical, acoustic, inductive, mechanical, chemical measurements, or any phenomena that can be measured with respect to the occurrences of the one or more touches or near touches in proximity to deice 3001. Software, hardware, firmware or any combination thereof may be used to process the measurements of the detected touches to identify and track one or more gestures. A gesture may correspond to stationary or non-stationary, single or multiple, touches or near touches on touch I/O device 3001. A gesture may be performed by moving one or more fingers or other objects in a particular manner on touch I/O device 3001 such as tapping, pressing, rocking, scrubbing, twisting, changing orientation, pressing with varying pressure and the like at essentially the same time, contiguously, or consecutively. A gesture may be characterized by, but is not limited to a pinching, sliding, swiping, rotating, flexing, dragging, or tapping motion between or with any other finger or fingers. A single gesture may be performed with one or more hands, by one or more users, or any combination thereof.

Computing system 3003 may drive a display with graphical data to display a graphical user interface (GUI). The GUI may be configured to receive touch input via touch I/O device 3001. Embodied as a touch screen, touch I/O device 3001 may display the GUI. Alternatively, the GUI may be displayed on a display separate from touch I/O device 3001. The GUI may include graphical elements displayed at particular locations within the interface. Graphical elements may include but are not limited to a variety of displayed virtual input devices including virtual scroll wheels, a virtual keyboard, virtual knobs, virtual buttons, any virtual UI, and the like. A user may perform gestures at one or more particular locations on touch I/O device 3001 which may be associated with the graphical elements of the graphical user interface (GUI). In other embodiments, the user may perform gestures at one or more locations that are independent of the locations of graphical elements of the GUI. Gestures performed on touch I/O device 3001 may directly or indirectly manipulate, control, modify, move, actuate, initiate or generally affect graphical elements such as cursors, icons, media files, lists, text, all or portions of images, or the like within the GUI. For instance, in the case of a touch screen, a user may directly interact with a graphical element by performing a gesture over the graphical element on the touch screen.

Alternatively, a touch pad generally provides indirect interaction. Gestures may also affect non-displayed GUI elements (e.g., causing user interfaces to appear) or may affect other actions within computing system 3003 (e.g., affect a state or mode of a GUI, application, or operating system). Gestures may or may not be performed on touch I/O device 3001 in conjunction with a displayed cursor. For instance, in the case in which gestures are performed on a touchpad, a cursor (or pointer) may be displayed on a display screen or touch screen and the cursor may be controlled via touch input on the touchpad to interact with graphical objects on the display screen. In other embodiments in which gestures are performed directly on a touch screen, a user may interact directly with objects on the touch screen, with or without a cursor or pointer being displayed on the touch screen.

Feedback may be provided to the user via communication channel 3002 in response to or based on the touch or near touches on touch I/O device 3001. Feedback may be transmitted optically, mechanically, electrically, olfactory, acoustically, or the like or any combination thereof and in a variable or non-variable manner.

A selection or user selection as discussed herein including the methods disclosed herein may be a touch input, gesture input, mouse, cursor, voice, or other input for performing a selection on a computing device.

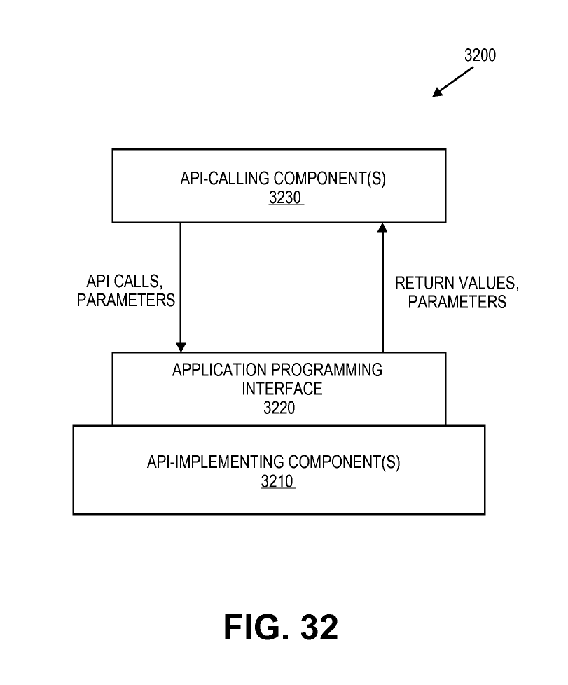

Attention is now directed towards embodiments of a system architecture that may be embodied within any portable or non-portable device including but not limited to a communication device (e.g. mobile phone, smart phone), a multi-media device (e.g., MP3 player, TV, radio), a portable or handheld computer (e.g., tablet, netbook, laptop), a desktop computer, an All-In-One desktop, a peripheral device, or any other system or device adaptable to the inclusion of system architecture 3100, including combinations of two or more of these types of devices. FIG. 31 is a block diagram of one embodiment of the present invention of system 3100 that generally includes one or more computer-readable mediums 3101, processing system 3104, Input/Output (I/O) subsystem 3106, radio frequency (RF) circuitry 3108 and audio circuitry 3110. These components may be coupled by one or more communication buses or signal lines 3103.

It should be apparent that the architecture shown in FIG. 31 is only one example architecture of system 3100, and that system 3100 could have more or fewer components than shown, or a different configuration of components. The various components shown in FIG. 31 can be implemented in hardware, software, firmware or any combination thereof, including one or more signal processing and/or application specific integrated circuits.

RF circuitry 3108 is used to send and receive information over a wireless link or network to one or more other devices and includes well-known circuitry for performing this function. RF circuitry 3108 and audio circuitry 3110 are coupled to processing system 3104 via peripherals interface 3116. Interface 3116 includes various known components for establishing and maintaining communication between peripherals and processing system 3104. Audio circuitry 3110 is coupled to audio speaker 3150 and microphone 3152 and includes known circuitry for processing voice signals received from interface 3116 to enable a user to communicate in real-time with other users. In some embodiments, audio circuitry 3110 includes a headphone jack (not shown).

Peripherals interface 3116 couples the input and output peripherals of the system to processor 3118 and computer-readable medium 3101. One or more processing units 3118 communicate with one or more computer-readable mediums 3101 via controller 3120. Computer-readable medium 3101 can be any device or medium (e.g., storage device, storage medium) that can store code and/or data for use by one or more processing units 3118. Medium 3101 can include a memory hierarchy, including but not limited to cache, main memory and secondary memory. The memory hierarchy can be implemented using any combination of RAM (e.g., SRAM, DRAM, DDRAM), ROM, FLASH, magnetic and/or optical storage devices, such as disk drives, magnetic tape, CDs (compact disks) and DVDs (digital video discs). Medium 3101 may also include a transmission medium for carrying information-bearing signals indicative of computer instructions or data (with or without a carrier wave upon which the signals are modulated). For example, the transmission medium may include a communications network, including but not limited to the Internet (also referred to as the World Wide Web), intranet(s), Local Area Networks (LANs), Wide Local Area Networks (WLANs), Storage Area Networks (SANs), Metropolitan Area Networks (MAN) and the like.

One or more processing units 3118 run various software components stored in medium 3101 to perform various functions for system 3100. In some embodiments, the software components include operating system 3122, communication module (or set of instructions) 3124, touch processing module (or set of instructions) 3126, graphics module (or set of instructions) 3128, one or more applications (or set of instructions) 3130, and game center module [or set of instructions] 3138. In an embodiment, a game center application is associated with a game center module 3138 that includes sub-modules (e.g., profile 210, friends 220, games 230, notifications 240). Each of these modules, sub-modules, and above noted applications correspond to a set of instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules may be combined or otherwise rearranged in various embodiments.

In some embodiments, medium 3101 may store a subset of the modules and data structures identified above. Furthermore, medium 3101 may store additional modules and data structures not described above.

Operating system 3122 includes various procedures, sets of instructions, software components and/or drivers for controlling and managing general system tasks (e.g., memory management, storage device control, power management, etc.) and facilitates communication between various hardware and software components.

Communication module 3124 facilitates communication with other devices over one or more external ports 3136 or via RF circuitry 3108 and includes various software components for handling data received from RF circuitry 3108 and/or external port 3136.

Graphics module 3128 includes various known software components for rendering, animating and displaying graphical objects on a display surface. In embodiments in which touch I/O device 3112 is a touch sensitive display (e.g., touch screen), graphics module 3128 includes components for rendering, displaying, and animating objects on the touch sensitive display.

One or more applications 3130 can include any applications installed on system 3100, including without limitation, a game center application, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player, etc.

Touch processing module 3126 includes various software components for performing various tasks associated with touch I/O device 3112 including but not limited to receiving and processing touch input received from I/O device 3112 via touch I/O device controller 3132. System 3100 may further include module 3138 having sub-modules (e.g., profile 210, friends 220, games 230, notifications 240) for performing the method/functions as described herein. In one embodiment, the module 3138 may at least function to provide personalized information for a non-acquired asset. For example, in at least certain embodiments, a module on a system provides personalized information for a non-acquired asset. The personalized information can be based on data related to the user's friends, friends of the user's friends, and the user. The module allows a user to access a first user account. The module causes a system to present at least a first asset that is inaccessible by the first user account. The first asset may be associated with a second user account that is linked to the first user account. The module may receive a selection of the first asset. The module, in response to the selection, causes the system to automatically present data related to the first asset. The data may be personalized to the first user account and based on the second user account.

In another embodiment, a system (e.g., 3003, 3100) includes a computer-readable medium (e.g., 3101) that stores a game center module 3138, one or more processing units (e.g., 3118) that execute a set of instructions associated with the game center module 3138, and an input/output device (e.g., 3001, 3112). The one or more processing units may be configured to receive a selection to initiate the game center application and associated game center module, to access a first user account and to cause a system to present at least a first asset that is inaccessible by the first user account. The first asset may be associated with a second user account that is linked to the first user account. The one or more processing units may be configured to receive a selection of the first asset and to cause the system to automatically present data related to the first asset. The data may be personalized to the first user account and based on the second user account. The data may be personalized to the first user account and based on the second user account by comparison of data derived from the first and second user accounts.

In another embodiment, the game center module provides provide personalized information to a user for a game owned by a friend but not owned by the user. The game center module 3138, which is executed with one or more processing units, receives one or more user selections of options provided by the game center module, causes the system in response to the one or more user selections to automatically present personalized options to access personalized details of a selected game owned by selected friend that a user does not own. The module may provide the user with an option to access the game and automatically directing the user to an application service to purchase the selected game in response to the selection of one of these games.

The personalized options further include a first personalized data option to provide a list of players that own the game upon selection of the first personalized data option, a second personalized data option to provide a leaderboard for the selected friend for the game upon selection of the first personalized data option; and a third personalized data option to provide achievement data for the selected friend for the game upon selection of the first personalized data option. The friend details of the selected friend further includes a list of games played together between the friend and the user and a list of other games in common between the friend and the user. The list of games owned by the friend that the user does not own further includes for each game in the listing a selectable option that displays a graphical icon for the game, a game manufacturer for the game, a game name, a rating for the game, and a price for purchasing the game.

Module 3138 may also interact with game center application 3130 to provide the methods and functionality described herein. Module 3138 may be embodied as hardware, software, firmware, or any combination thereof. Although module 3138 is shown to reside within medium 3101, all or portions of module 3138 may be embodied within other components within system 3100 or may be wholly embodied as a separate component within system 3100.

I/O subsystem 3106 is coupled to touch I/O device 3112 and one or more other I/O devices 3114 for controlling or performing various functions. Touch I/O device 3112 communicates with processing system 3104 via touch I/O device controller 2032, which includes various components for processing user touch input (e.g., scanning hardware). One or more other input controllers 2034 receives/sends electrical signals from/to other I/O devices 3114. Other I/O devices 3114 may include physical buttons, dials, slider switches, sticks, keyboards, touch pads, additional display screens, or any combination thereof.

If embodied as a touch screen, touch I/O device 3112 displays visual output to the user in a GUI. The visual output may include text, graphics, video, and any combination thereof. Some or all of the visual output may correspond to user-interface objects. Touch I/O device 3112 forms a touch-sensitive surface that accepts touch input from the user. Touch I/O device 3112 and touch screen controller 3132 (along with any associated modules and/or sets of instructions in medium 3101) detects and tracks touches or near touches (and any movement or release of the touch) on touch I/O device 3112 and converts the detected touch input into interaction with graphical objects, such as one or more user-interface objects. In the case in which device 3112 is embodied as a touch screen, the user can directly interact with graphical objects that are displayed on the touch screen. Alternatively, in the case in which device 3112 is embodied as a touch device other than a touch screen (e.g., a touch pad), the user may indirectly interact with graphical objects that are displayed on a separate display screen embodied as I/O device 3114.

Touch I/O device 3112 may be analogous to the multi-touch sensitive surface described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference.

Embodiments in which touch I/O device 3112 is a touch screen, the touch screen may use LCD (liquid crystal display) technology, LPD (light emitting polymer display) technology, OLED (organic LED), or OEL (organic electro luminescence), although other display technologies may be used in other embodiments.

Feedback may be provided by touch I/O device 3112 based on the user's touch input as well as a state or states of what is being displayed and/or of the computing system. Feedback may be transmitted optically (e.g., light signal or displayed image), mechanically (e.g., haptic feedback, touch feedback, force feedback, or the like), electrically (e.g., electrical stimulation), olfactory, acoustically (e.g., beep or the like), or the like or any combination thereof and in a variable or non-variable manner.

System 3100 also includes power system 3144 for powering the various hardware components and may include a power management system, one or more power sources, a recharging system, a power failure detection circuit, a power converter or inverter, a power status indicator and any other components typically associated with the generation, management and distribution of power in portable devices.

In some embodiments, peripherals interface 3116, one or more processing units 3118, and memory controller 3120 may be implemented on a single chip, such as processing system 3104. In some other embodiments, they may be implemented on separate chips.

In certain embodiments of the present disclosure, the system 3003 or system 3100 or combinations of systems 3003 or 3100 can be used to implement at least some of the methods discussed in the present disclosure.

Some portions of the detailed descriptions are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing or transmitting information in a form readable by a machine (e.g., a computer). For example, machines store and communicate (internally and with other devices over a network) code and data using machine-readable media, such as machine storage media (e.g., magnetic disks; optical disks; random access memory; read only memory; flash memory devices; phase-change memory).

One or more Application Programming Interfaces (APIs) may be used in some embodiments. An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component.

An API allows a developer of an API-calling component (which may be a third party developer) to leverage specified features provided by an API-implementing component. There may be one API-calling component or there may be more than one such component. An API can be a source code interface that a computer system or program library provides in order to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some embodiments the API-implementing component may provide more than one API, each providing a different view of or with different aspects that access different aspects of the functionality implemented by the API-implementing component. For example, one API of an API-implementing component can provide a first set of functions and can be exposed to third party developers, and another API of the API-implementing component can be hidden (not exposed) and provide a subset of the first set of functions and also provide another set of functions, such as testing or debugging functions which are not in the first set of functions. In other embodiments the API-implementing component may itself call one or more other components via an underlying API and thus be both an API-calling component and an API-implementing component.

An API defines the language and parameters that API-calling components use when accessing and using specified features of the API-implementing component. For example, an API-calling component accesses the specified features of the API-implementing component through one or more API calls or invocations (embodied for example by function or method calls) exposed by the API and passes data and control information using parameters via the API calls or invocations. The API-implementing component may return a value through the API in response to an API call from an API-calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API-calling component) and an API-implementing component. Transferring the API calls may include issuing, initiating, invoking, calling, receiving, returning, or responding to the function calls or messages; in other words, transferring can describe actions by either of the API-calling component or the API-implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API-implementing component. Thus, the API-calling component may declare variables, use pointers to, use or instantiate constant values of such types or classes by using definitions provided in the API.

Generally, an API can be used to access a service or data provided by the API-implementing component or to initiate performance of an operation or computation provided by the API-implementing component. By way of example, the API-implementing component and the API-calling component may each be any one of an operating system, a library, a device driver, an API, an application program, or other module (it should be understood that the API-implementing component and the API-calling component may be the same or different type of module from each other). API-implementing components may in some cases be embodied at least in part in firmware, microcode, or other hardware logic. In some embodiments, an API may allow a client program (e.g., game center application) to use the services provided by a Software Development Kit (SDK) library. In other embodiments an application or other client program may use an API provided by an Application Framework. In these embodiments the application or client program may incorporate calls to functions or methods provided by the SDK and provided by the API or use data types or objects defined in the SDK and provided by the API. An Application Framework may in these embodiments provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability, power state, storage capacity and state, communications capability, etc., and the API may be implemented in part by firmware, microcode, or other low level logic that executes in part on the hardware component.

The API-calling component may be a local component (i.e., on the same data processing system as the API-implementing component) or a remote component (i.e., on a different data processing system from the API-implementing component) that communicates with the API-implementing component through the API over a network. It should be understood that an API-implementing component may also act as an API-calling component (i.e., it may make API calls to an API exposed by a different API-implementing component) and an API-calling component may also act as an API-implementing component by implementing an API that is exposed to a different API-calling component.

The API may allow multiple API-calling components written in different programming languages to communicate with the API-implementing component (thus the API may include features for translating calls and returns between the API-implementing component and the API-calling component); however the API may be implemented in terms of a specific programming language. An API-calling component can, in one embedment, call APIs from different providers such as a set of APIs from an OS provider and another set of APIs from a plug-in provider and another set of APIs from another provider (e.g. the provider of a software library) or creator of the another set of APIs.

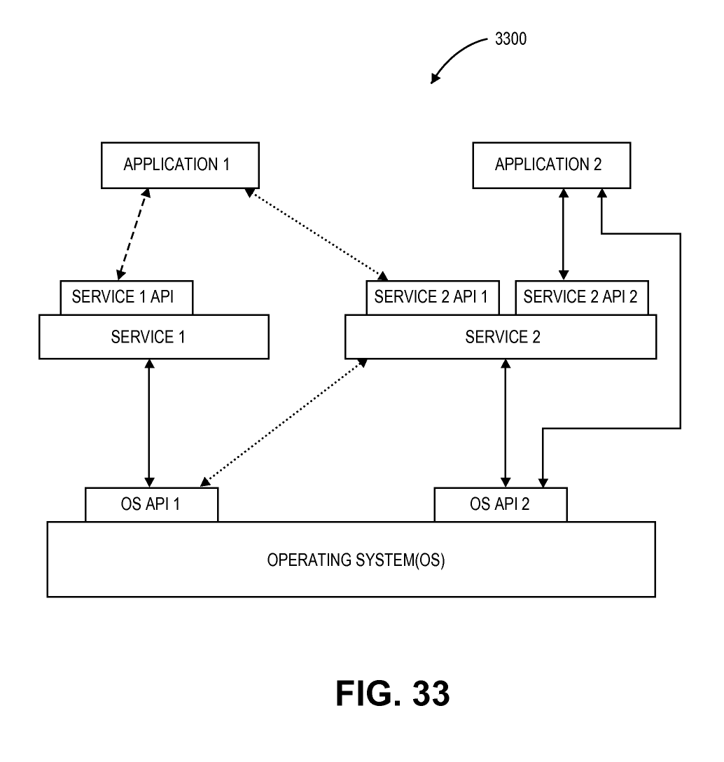

FIG. 32 is a block diagram illustrating an exemplary API architecture, which may be used in one embodiment of the present invention. As shown in FIG. 32, the API architecture 3200 includes the API-implementing component 3210 (e.g., an operating system, a library, a device driver, an API, an application program, software or other module) that implements the API 3220. The API 3220 specifies one or more functions, methods, classes, objects, protocols, data structures, formats and/or other features of the API-implementing component that may be used by the API-calling component 3230. The API 3220 can specify at least one calling convention that specifies how a function in the API-implementing component receives parameters from the API-calling component and how the function returns a result to the API-calling component. The API-calling component 3230 (e.g., an operating system, a library, a device driver, an API, an application program, software or other module) makes API calls through the API 3220 to access and use the features of the API-implementing component 3210 that are specified by the API 3220. The API-implementing component 3210 may return a value through the API 3220 to the API-calling component 3230 in response to an API call.

It will be appreciated that the API-implementing component 3210 may include additional functions, methods, classes, data structures, and/or other features that are not specified through the API 3220 and are not available to the API-calling component 3230. It should be understood that the API-calling component 3230 may be on the same system as the API-implementing component 3210 or may be located remotely and accesses the API-implementing component 3210 using the API 3220 over a network. While FIG. 32 illustrates a single API-calling component 3230 interacting with the API 3220, it should be understood that other API-calling components, which may be written in different languages (or the same language) than the API-calling component 3230, may use the API 3220.

The API-implementing component 3210, the API 3220, and the API-calling component 3230 may be stored in a machine-readable medium (e.g., computer-readable medium), which includes any mechanism for storing information in a form readable by a machine (e.g., a computer or other data processing system). For example, a machine-readable medium includes magnetic disks, optical disks, random access memory; read only memory, flash memory devices, etc.

In FIG. 33 (“Software Stack”), in one embodiment of the present invention, applications can make calls to Services A or B using several Service APIs and to Operating System (OS) using several OS APIs. Services A and B can make calls to OS using several OS APIs.

Note that the Service 2 has two APIs, one of which (Service 2 API 1) receives calls from and returns values to Application 1 and the other (Service 2 API 2) receives calls from and returns values to Application 2. Service 1 (which can be, for example, a software library) makes calls to and receives returned values from OS API 1, and Service 2 (which can be, for example, a software library) makes calls to and receives returned values from both OS API 1 and OS API 2. Application 2 makes calls to and receives returned values from OS API 2.

In the foregoing specification, the disclosure has been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method comprising:
accessing a user account;
causing a system to present at least a first asset that is inaccessible by a first user account, wherein the first asset is associated with a second user account that is linked to the first user account;
receiving a selection of the first asset;
in response to the selection, causing the system to automatically present data related to the first asset, wherein the data is personalized to the first user account and based on the second user account.

2. The computer-implemented method of claim 1, wherein the data is personalized to the first user account and based on the second user account by comparison of data derived from the first and second user accounts.

3. The computer-implemented method of claim 1, wherein the first user account and the second user account are associated with the user.

4. The computer-implemented method of claim 1, wherein the first user account is associated with the user and the second user account is associated with a friend of the user.

5. The computer-implemented method of claim 1, wherein the first asset is associated with a third user account that is linked to the second user account.

6. The computer-implemented method of claim 5, wherein the data is personalized to the first user account and based on the second and third user accounts by comparison of data derived from the first, second, and third user accounts.

7. The computer-implemented method of claim 6, wherein the first user account is associated with the user, the second user account is associated with a friend of the user, and the third user account is associated with a friend of the friend of the user.

8. A computer-readable medium containing executable computer program instructions which when executed by a computing system cause said system to perform a method, the method comprising:
accessing a user account;
causing a system to present at least a first asset that is inaccessible by a first user account, wherein the first asset is associated with a second user account that is linked to the first user account;
receiving a selection of the first asset; and
in response to the selection, causing the system to automatically present data related to the first asset, wherein the data is personalized to the first user account and based on the second user account.

9. The computer-readable medium of claim 8, wherein the data is personalized to the first user account and based on the second user account by comparison of data derived from the first and second user accounts.

10. The computer-readable medium of claim 8, wherein the first user account and the second user account are associated with the user.

11. The computer-readable medium of claim 8, wherein the first user account is associated with the user and the second user account is associated with a friend of the user.

12. The computer-readable medium of claim 8, wherein the first asset is associated with a third user account that is linked to the second user account.

13. The computer-readable medium of claim 12, wherein the data is personalized to the first user account and based on the second and third user accounts by comparison of data derived from the first, second, and third user accounts.

14. The computer-readable medium of claim 13, wherein the first user account is associated with the user, the second user account is associated with a friend of the user, and the third user account is associated with a friend of the friend of the user.

15. A computer-implemented method comprising:
receiving one or more user selections of a game center module; and
causing the graphical user interface of the system in response to the one or more user selections to automatically present personalized options for accessing personalized information of a selected game owned by selected friend that a user does not own.

16. The computer-implemented method of claim 15, further comprising:
providing the user with an option to access the game; and
automatically directing the user to an application service to purchase the selected game in response to the selection of one of these games.

17. The computer-implemented method of claim 15, wherein the personalized options further comprising:
a first personalized data option to provide a list of players that own the game upon selection of the first personalized data option;
a second personalized data option to provide a leaderboard for the selected friend for the game upon selection of the first personalized data option; and
a third personalized data option to provide achievement data for the selected friend for the game upon selection of the first personalized data option.

18. The computer implemented method of claim 15, wherein the one or more user selections comprise a friends option and a friends list option or a games option and a games list option.

19. A computer-readable medium containing executable computer program instructions which when executed by a computing system cause said system to perform a method, the method comprising:
receiving one or more user selections of a game center module; and
causing the graphical user interface of the system in response to the one or more user selections to automatically present personalized options for accessing personalized information of a selected game owned by a selected friend that a user does not own.

20. The computer-readable medium of claim 19, further comprising:
providing the user with an option to access the game; and
automatically directing the user to an application service to purchase the selected game in response to the selection of one of these games.

21. The computer-readable medium of claim 19, wherein the personalized options further comprising:
a first personalized data option to provide a list of players that own the game upon selection of the first personalized data option;
a second personalized data option to provide a leaderboard for the selected friend for the game upon selection of the first personalized data option; and
a third personalized data option to provide achievement data for the selected friend for the game upon selection of the first personalized data option.

22. The computer-readable medium of claim 19, wherein the one or more user selections comprise a friends option and a friends list option or a games option and a games list option.

23. A system, comprising:
a computer-readable medium to store a game center module;
one or more processing units coupled to the computer-readable medium; and
an input/output device coupled to the one or more processing units, wherein the one or more processing units are configured to access a user account, to cause a system to present at least a first asset that is inaccessible by a first user account and is associated with a second user account that is linked to the first user account, to receive a selection of the first asset, and to cause, in response to the selection, the system to automatically present data related to the first asset, wherein the data is personalized to the first user account and based on the second user account.

24. The system of claim 23, wherein the data is personalized to the first user account and based on the second user account by comparison of data derived from the first and second user accounts.

25. The system of claim 23, wherein the first user account and the second user account are associated with the user.
